(19) United States
(12) Patent Application Publication
(10) Pub. No.: US 2025/0126449 A1
(43) Pub. Date: Apr. 17, 2025

(54) HIGH-PRIORITY MESSAGE BROADCAST FOR AUTONOMOUS USER EQUIPMENTS (UES)

(71) Applicant: QUALCOMM Incorporated, San Diego, CA (US)

(72) Inventors: Harish Singh BISHT, Lalkuan (IN); Rajesh KOTHA, Hyderabad (IN); Stephen William EDGE, Escondido, CA (US); Vishnu Vardhan Reddy MENDE, Hyderabad (IN); Sandeep LNU, GURGAON (IN)

(21) Appl. No.: 18/291,327

(22) PCT Filed: Aug. 30, 2022
(86) PCT No.: PCT/US2022/042016

§ 371 Date: Jan. 23, 2024

(30) Foreign Application Priority Data
Sep. 30, 2021 (IN) 202141044447

(51) Int. Cl. H04W 4/90; H04W 4/024; H04W 4/06; H04W 4/14; H04W 4/44

(52) U.S. Cl. CPC H04W 4/90; H04W 4/024; H04W 4/06; H04W 4/14; H04W 4/44

(57) ABSTRACT

The aspects described herein enable an apparatus (e.g., an autonomous user equipment (UE), such as an unmanned aerial vehicles (UAV), an autonomous vehicle (AV), and an autonomous consumer Internet of things (CIoT) device, for example) to receive a notification message indicating a transmission of a high-priority message for one or more autonomous UEs, receive the high-priority message, wherein the high-priority message indicates at least one command associated with the one or more autonomous UEs, and perform the at least one command based on the high-priority message. In some examples, the high-priority message may be a new system information block (SIB) for autonomous UEs.

### CROSS-REFERENCE TO RELATED APPLICATION

This application claims priority to and the benefit of Indian Application Serial No. 202141044447, entitled “HIGH-PRIORITY MESSAGE BROADCAST FOR AUTONOMOUS USER EQUIPMENTS (UES),” filed on Sep. 30, 2021, the entire contents of which are incorporated herein by reference as if fully set forth below in its entirety and for all applicable purposes.

### BACKGROUND

### Technical Field

The present disclosure relates generally to communication systems, and more particularly, to high-priority message broadcasts for autonomous devices.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The number of autonomous user equipments (UEs) (e.g., unmanned aerial vehicles (UAVs), autonomous vehicles (AVs), autonomous consumer Internet of Things (CIoT) devices and/or other autonomous devices) in wireless communication networks (e.g., 5G NR networks) is continuously increasing. Consequently, there is a growing need for mechanisms that enable delivery of high-priority messages to autonomous UEs. For example, the high-priority messages may be messages warning of an impending emergency, such as a tsunami, tornado, fire, and/or other type of emergency.

In some cases, delivery of high-priority messages to autonomous UEs may alert the autonomous UEs as to the type and/or location of the emergency. This may allow autonomous UEs to escape or avoid areas that may pose a danger to the autonomous UEs and/or users of the autonomous UEs. However, existing wireless communication networks may not have a mechanism to broadcast such high-priority messages to autonomous UEs.

In an aspect of the disclosure, a method, a computer-readable medium, and an apparatus are provided. The apparatus (e.g., an autonomous UE) receives a notification message indicating a transmission of a high-priority message for one or more autonomous user equipments (UEs), receives the high-priority message, wherein the high-priority message indicates at least one command associated with the one or more autonomous UEs, and performs the at least one command based on the high-priority message.

In an aspect of the disclosure, an apparatus for wireless communication is provided. The apparatus includes means for receiving a notification message indicating a transmission of a high-priority message for one or more autonomous user equipments (UEs), means for receiving the high-priority message, wherein the high-priority message indicates at least one command associated with the one or more autonomous UEs, and means for performing the at least one command based on the high-priority message. In some aspects, the apparatus further includes means for transmitting a response message based on the high-priority message.

In some aspects, the notification message is a broadcast short message. In some aspects, the broadcast short message includes eight bits, and wherein the transmission of the high-priority message is indicated in a fourth bit, a fifth bit, a sixth bit, a seventh bit, or an eighth bit of the broadcast short message.

In some aspects, the at least one command associated with the one or more autonomous UEs includes at least one of a transmit location command to transmit a current location, a release command to initiate a wireless connection release procedure, a preconfigured travel command to travel to a preconfigured location or along a preconfigured path, a safe location command to travel to a location indicated in the high-priority message, an updated path command to travel along an updated path, a play message command to play at least one of an audio message, a video message, a multimedia message, or a text message, a transmit signal command to transmit at least one of an audio signal, a visual signal or a radio frequency (RF) signal, an altitude change command to change an altitude of the one or more autonomous UEs, an exit area command to travel away from an area, and a stop command to stop for one or more types of vehicles.

In some aspects, at least a portion of the audio message, the video message, the multimedia message, the text message, the audio signal, the visual signal, the RF signal, a value of the altitude, or the updated path, is included in the high-priority message.

In some aspects, the location indicated in the high-priority message includes a set of coordinates.

In some aspects, the at least one command is included in one of a plurality of command classes, wherein each of the plurality of command classes includes a set of commands for a single autonomous UE type, multiple autonomous UE types, or all autonomous UE types.

In some aspects, the high-priority message further indicates information to be transmitted from the one or more autonomous UEs in response to the high-priority message or in response to an initiation or a completion of the at least one command, wherein the information includes acknowledgement information, location information, or an indication of an initiation or completion of a command, and wherein the response message includes the information.

In some aspects, the one or more autonomous UEs includes at least one of an unmanned aerial vehicle (UAV), an autonomous vehicle (AV), or an autonomous consumer Internet of Things (CIoT) device.

In some aspects, the high-priority message is a system information block (SIB).

In some aspects, the system information block (SIB) includes at least one of a message identifier parameter, a serial number parameter, a command parameter, a command extension parameter, a command string parameter, a command response parameter, or a coordinates parameter.

In an aspect of the disclosure, a computer-readable medium storing computer executable code is provided. The code when executed by a processor cause the processor to: receive a notification message indicating a transmission of a high-priority message for one or more autonomous user equipments (UEs), receive the high-priority message, wherein the high-priority message indicates at least one command associated with the one or more autonomous UEs, and perform the at least one command based on the high-priority message. In some aspects, the code when executed by the processor further cause the processor to: transmit a response message based on the high-priority message.

In an aspect of the disclosure, a method, a computer-readable medium, and an apparatus are provided. The apparatus (e.g., a base station) transmits a notification message indicating a transmission of a high-priority message for one or more autonomous user equipments (UEs), and transmits the high-priority message, wherein the high-priority message indicates at least one command associated with the one or more autonomous UEs.

In an aspect of the disclosure, an apparatus for wireless communication includes means for transmitting a notification message indicating a transmission of a high-priority message for one or more autonomous user equipments (UEs), and means for transmitting the high-priority message, wherein the high-priority message indicates at least one command associated with the one or more autonomous UEs.

In some aspects, the apparatus further includes means for receiving a request to transmit the at least one command associated with the one or more autonomous UEs, wherein the notification message and the high-priority message are transmitted in response to the request.

In some aspects, the notification message is a broadcast short message. In some aspects, the broadcast short message includes eight bits, and wherein the transmission of the high-priority message is indicated in a fourth bit, a fifth bit, a sixth bit, a seventh bit, or an eighth bit of the broadcast short message.

In some aspects, the at least one command associated with the one or more autonomous UEs includes a transmit location command to transmit a current location, a release command to initiate a wireless connection release procedure, a preconfigured travel command to travel to a preconfigured location or along a preconfigured path, a safe location command to travel to a location indicated in the high-priority message, an updated path command to travel along an updated path, a play message command to play at least one of an audio message, a video message, a multimedia message, or a text message, a transmit signal command to transmit at least one of an audio signal, a visual signal or a radio frequency (RF) signal, an altitude change command to change an altitude of the one or more autonomous UEs, an exit area command to travel away from an area, and/or a stop command to stop for one or more types of vehicles.

In some aspects, at least a portion of the audio message, the video message, the multimedia message, the text message, the audio signal, the visual signal, the RF signal, a value of the altitude, or the updated path, is included in the high-priority message.

In some aspects, the location indicated in the high-priority message includes a set of coordinates.

In some aspects, the at least one command is included in one of a plurality of command classes, wherein each of the plurality of command classes includes a set of commands for a single autonomous UE type, multiple autonomous UE types, or all autonomous UE types.

In some aspects, the apparatus further includes means for receiving a response message from the one or more autonomous UEs based on the high-priority message. In some aspects, the high-priority message further indicates information to be transmitted from the one or more autonomous UEs in response to the high-priority message or in response to an initiation or a completion of the at least one command, wherein the information includes acknowledgement information, location information, or an indication of an initiation or completion of the at least one command, and wherein the response message includes the information.

In some aspects, the apparatus further includes means for forwarding the information in the response message to an autonomous UE management entity or an entity indicated in the response message.

In some aspects, the apparatus further includes means for transmitting an update message to one or more controllers of the one or more autonomous UEs based on the response message. In some aspects, the one or more autonomous UEs includes at least one of an unmanned aerial vehicle (UAV), an autonomous vehicle (AV), or an autonomous consumer Internet of Things (CIoT) device.

In some aspects, the high-priority message is a system information block (SIB).

In some aspects, the system information block (SIB) includes at least one of a message identifier parameter, a serial number parameter, a command parameter, a command extension parameter, a command string parameter, a command response parameter, or a coordinates parameter.

In an aspect of the disclosure, a computer-readable medium storing computer executable code is provided. The code when executed by a processor cause the processor to: transmit a notification message indicating a transmission of a high-priority message for one or more autonomous user equipments (UEs), and transmit the high-priority message, wherein the high-priority message indicates at least one command associated with the one or more autonomous UEs.

In some aspects, the code when executed by the processor further cause the processor to: receive a request to transmit the at least one command associated with the one or more autonomous UEs, wherein the notification message and the high-priority message are transmitted in response to the request. In some aspects, the code when executed by the processor further cause the processor to: receive a response message from the one or more autonomous UEs based on the high-priority message. In some aspects, the code when executed by the processor further cause the processor to: forward the information in the response message to an autonomous UE management entity or an entity indicated in the response message. In some aspects, the code when executed by the processor further cause the processor to: transmit an update message to one or more controllers of the one or more autonomous UEs based on the response message.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and a user equipment (UE) in an access network.

FIG. 4 illustrates a signal flow diagram in accordance with various aspects of the present disclosure.

FIG. 5 illustrates an example network including a base station and a number of autonomous devices in accordance with various aspects of the present disclosure.

FIG. 6 illustrates a diagram including example parameters and parameter values for a high-priority message in accordance with various aspects of the present disclosure.

FIG. 7 is a flowchart of a method of wireless communication in accordance with various aspects of the present disclosure.

FIG. 8 is a conceptual data flow diagram illustrating the data flow between different means/components in an example apparatus in accordance with various aspects of the present disclosure.

FIG. 9 is a diagram illustrating an example of a hardware implementation for an apparatus employing a processing system in accordance with various aspects of the present disclosure.

FIG. 10 is a flowchart of a method of wireless communication in accordance with various aspects of the present disclosure.

FIG. 11 is a conceptual data flow diagram illustrating the data flow between different means/components in an example apparatus in accordance with various aspects of the present disclosure.

FIG. 12 is a diagram illustrating an example of a hardware implementation for an apparatus employing a processing system in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

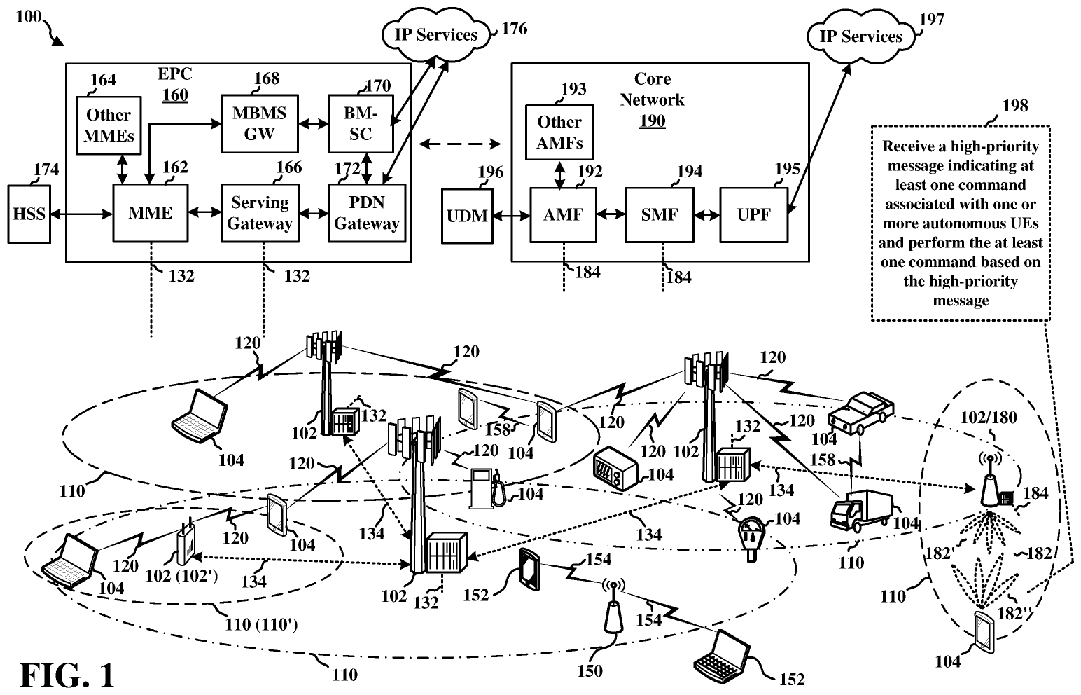

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a geographic coverage area 110′ that overlaps the geographic coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain ones of UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB base station 180 may operate in a traditional sub 6 GHz spectrum, in millimeter wave (mmW) frequencies, and/or near mmW frequencies in communication with the UE 104. When the gNB base station 180 operates in mmW or near mmW frequencies, the gNB base station 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave (mmW). Near mmW may extend down to a frequency of 3 GHz with a wavelength of 100 millimeters. The super high frequency (SHF) band extends between 3 GHZ and 30 GHZ, also referred to as centimeter wave. Communications using the mmW/near mmW radio frequency band (e.g., 3 GHZ-300 GHz) has extremely high path loss and a short range. The mmW gNB base station 180 may utilize beamforming 182 with the UE 104 to compensate for the extremely high path loss and short range.

The gNB base station 180 may transmit a beamformed signal to the UE 104 in one or more transmit directions 182′. The UE 104 may receive the beamformed signal from the gNB base station 180 in one or more receive directions 182″. The UE 104 may also transmit a beamformed signal to the gNB base station 180 in one or more transmit directions. The gNB base station 180 may receive the beamformed signal from the UE 104 in one or more receive directions. The gNB base station 180/UE 104 may perform beam training to determine the best receive and transmit directions for each of the gNB base station 180/UE 104. The transmit and receive directions for the gNB base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. Some of the UEs 104 may be referred to as autonomous UEs.

Referring again to FIG. 1, in certain aspects, the UE 104 may be an autonomous UE and may be configured to receive a high-priority message indicating at least one command associated with one or more autonomous UEs and may perform the at least one command based on the high-priority message (198). Although the following description may be focused on 5G NR, the concepts described herein may be applicable to other similar technology areas, such as LTE, LTE-A, CDMA, GSM, and other wireless technologies.

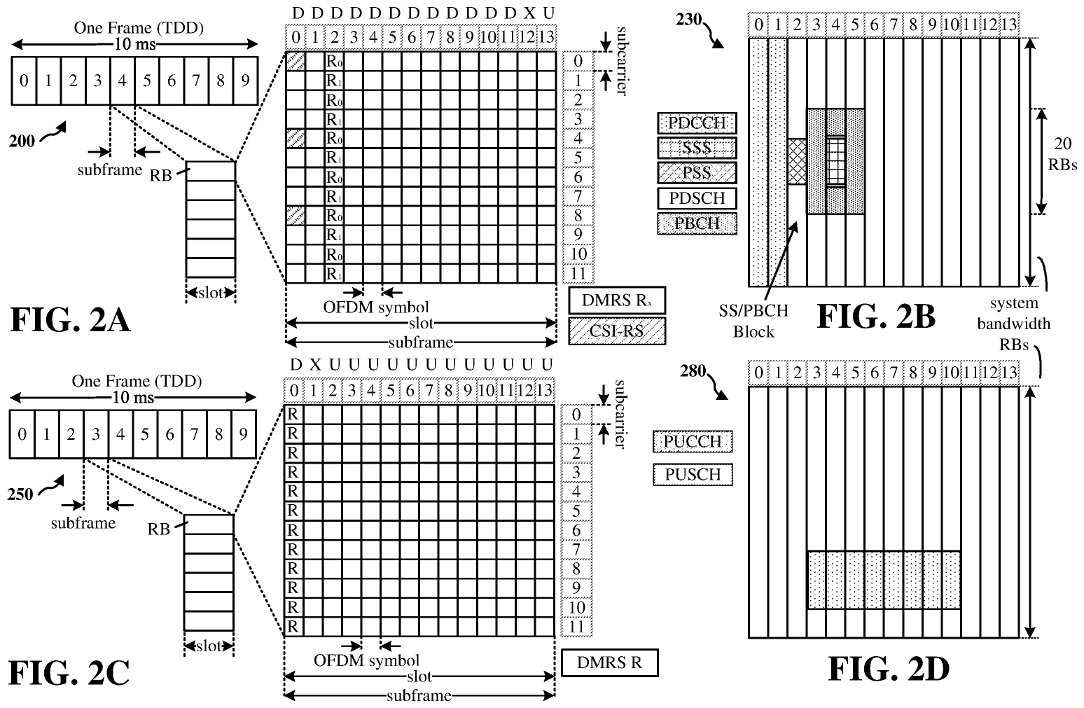

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 24 slots/subframe. The subcarrier spacing and symbol length/duration are a function of the numerology. The subcarrier spacing may be equal to 2^{μ}*15 kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

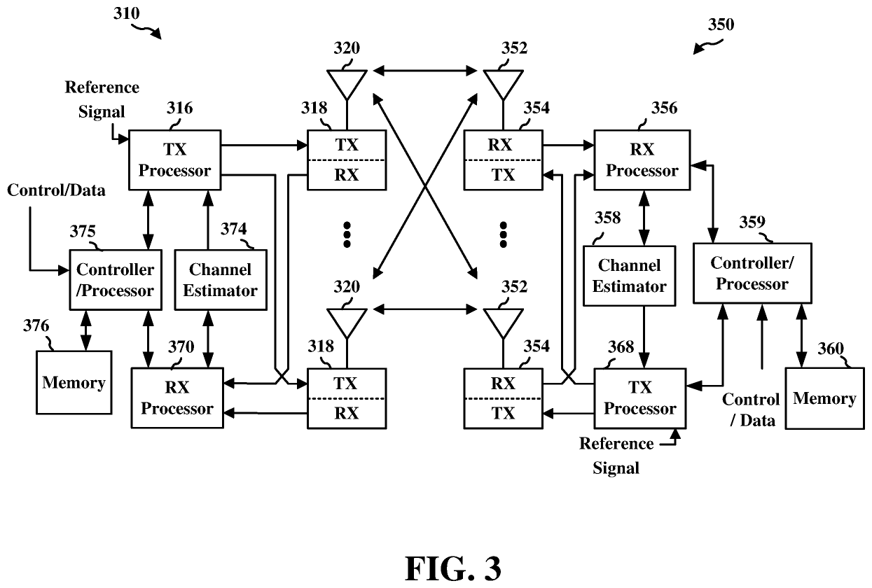

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

Wireless communication networks (e.g., 5G NR networks) may broadcast high-priority messages to UEs. For example, the high-priority messages may include emergency warnings of a public warning system (PWS) as specified by the Third Generation Partnership Program (3GPP). In some examples, the emergency warnings may relate to weather emergencies (e.g., tornadoes, hurricanes), geological events (e.g., earthquakes, tsunamis), and/or other types of emergencies and events. These high-priority messages may enable the PWS to reach out to a public mass via the UEs and to warn the public mass of impending emergencies.

Some wireless communication networks may support autonomous devices (also referred to as autonomous UEs). The aspects described herein may enable a wireless communication network to broadcast high-priority messages to these autonomous devices. For example, a broadcast of a high-priority message to one or more autonomous UEs may enable communication of emergency information to the one or more autonomous UEs, where a user may not be present to interpret and act on the emergency information.

In some examples, an autonomous UE may be, or may be associated with, an autonomous mobile entity, such as an unmanned aerial vehicle (UAV), an autonomous vehicle (AV), a consumer Internet of Things (CIoT) device (also referred to as an autonomous CIoT device or an autonomous CIoT UE), and/or other type of autonomous device capable of communicating with a wireless communication network (e.g., a base station). In some examples, an autonomous UE may be an automated device for farming, forestry, construction etc. In the aspects described herein, the term autonomous UE may also refer to a semiautonomous UE.

For example, a UAV may be a self-navigating aircraft, such as a drone (e.g., a quadcopter). For example, an AV may be a self-navigating vehicle (also referred to as a driverless vehicle), such as a self-driving or self-maneuvering automobile or truck. In another example, an AV may be a self-navigating water vessel (also referred to as a driverless water vessel), such as a self-navigating boat. An autonomous CIoT device may be a consumer device capable of communicating with a wireless communication network (e.g., a base station), such as a portable audio device (e.g., a wireless speaker), a home appliance, a security system device (e.g., a security camera and/or monitor), a wearable device, a home automation device, and/or other type of consumer device capable of communicating with a wireless communication network (e.g., a 5G NR network).

The term autonomous UE as used herein may refer to a UE that is associated with (e.g., a part of or connected to) an autonomous entity or device (e.g., a UAV, a drone, a driverless car or truck, or an automated and possibly mobile device used in farming, forestry, mining, construction, a factory, or a warehouse). In some examples, an autonomous UE may not have a user and may communicate data to and from an autonomous entity or device with which it is associated. For example, the autonomous entity or device may contain a processing device and memory as well as software or firmware instructions, which may enable the autonomous entity or device to generate data, and interpret and respond to received data. The term autonomous UE as used herein may refer to the autonomous entity or device combined with a capability to communicate as a UE with a wireless network (e.g., the access network 100 in FIG. 1) or may refer just to a modem and/or other communication capability that functions as a UE and supports communication on behalf of the associated autonomous entity or device.

The aspects described herein may allow for high-priority broadcasts to autonomous UEs without impacting other devices (e.g., non-autonomous UEs, such as cellular phones, smartphones, etc.) operating in a wireless communication network (e.g., a 5G NR network). For example, the aspects described herein may enable a 3GPP system to support emergency broadcast services for autonomous UEs by allowing third parties (e.g., authorized third parties, such as an air traffic control (ATC) entity, a police department, a vehicular traffic control system, etc.) to distribute emergency information and to issue commands to the autonomous UEs.

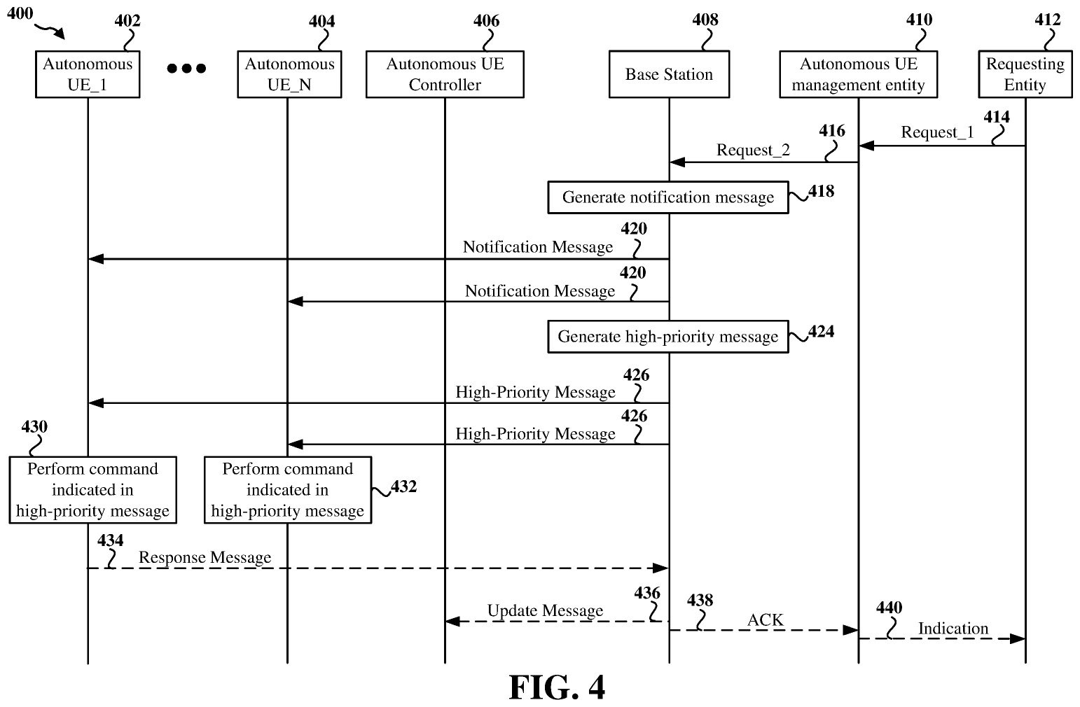

FIG. 4 illustrates an example signal flow diagram 400 in accordance with various aspects of the present disclosure. The signal flow diagram 400 includes a number of autonomous UEs (e.g., a first autonomous UE (UE_1) 402, an Nth autonomous UE (UE_N) 404), an autonomous UE controller 406, a base station 408, an autonomous UE management entity 410, and a requesting entity 412. In FIG. 4, transmissions indicated with dashed lines represent optional transmissions.

The autonomous UEs in FIG. 4 (e.g., autonomous UE_1 402, autonomous UE_N 404) may include a UAV, an AV, an autonomous CIoT device and/or other type of autonomous device capable of communicating with a wireless communication network (e.g., the base station 408). The autonomous UE controller 406 may be a device configured to provide control information (e.g., destination coordinates, a command to return and land/stop at a home location, and/or other suitable control information) to an autonomous UE. For example, if the autonomous UE_1 402 is a UAV, the autonomous UE controller 406 may transmit control information (e.g., via a WiFi connection if the UE_1 402 is nearby) to the UAV to control the takeoff, altitude, flightpath, speed, and/or landing of the UAV. In some examples, the autonomous UE controller 406 may be an off-board device with respect to the one or more autonomous UEs (e.g., autonomous UE_1 402, autonomous UE_N 404).

The requesting entity 412 may be an entity entrusted or authorized to distribute (e.g., broadcast) high-priority messages to autonomous UEs. For example, the requesting entity 412 may be an authorized third party (or a device under the control of the authorized third party), such as a police department, an emergency medical service (EMS) entity, an air traffic control (ATC) entity, a vehicular traffic control system, and/or any other appropriate public or private authorized third party).

The requesting entity 412 may transmit a first request (request_1) 414 to broadcast a high-priority message to autonomous UEs. In some examples, the request_1 414 may indicate one or more commands for the one or more autonomous UEs. In some examples, the request_1 414 may further indicate information (e.g., emergency information) to be distributed to the one or more autonomous UEs. For example, the one or more commands and/or information to be distributed to the autonomous UEs may be associated with the previously described Public Warning Systems (PWS), which may include the Commercial Mobile Alert System (CMAS), the Earthquake and Tsunami Warning System (ETWS), and/or other such systems.

In some examples, the autonomous UE management entity 410 may be an Unmanned Aerial System Traffic Management (UTM) entity. The autonomous UE management entity 410 may include a set of functions and services for managing a range of autonomous UE operations. The autonomous UE management entity 410 may receive the request_1 414 and may transmit a second request (request_2) 416 to the base station 408. In some examples, the request_2 416 may include the one or more commands for the one or more autonomous UEs in the request_1 414 and the information (e.g., emergency information) to be distributed to the one or more autonomous UEs in a form (e.g., parameter values) that enables the base station 408 to efficiently interpret and broadcast the one or more commands for the one or more autonomous UEs and/or the information (e.g., emergency information) to be distributed to the one or more autonomous UEs.

The base station 408 may receive the request_2 416, and at 418, the base station 408 may generate a notification message (e.g., the notification message 420) indicating a transmission of a high-priority message for one or more autonomous UEs in response to the request_2 416. In some aspects of the disclosure, the notification message 420 may enable autonomous UEs in an idle state (e.g., RRC idle state) or an inactive state (e.g., RRC inactive state) to transition to an active state and acquire a high-priority message for autonomous UEs. In some aspects of the disclosure, the high-priority message may be a new system information block (SIB) for autonomous UEs (also referred to as a new SIB or a SIB for autonomous UEs) as described herein.

The base station 408 may broadcast (e.g., transmit) the notification message generated at 418. In the example of FIG. 4, the base station 408 may broadcast the notification message 420 generated at 418.

At 424, the base station 408 may generate a high-priority message for one or more autonomous UEs (e.g., the autonomous UE_1 402, the autonomous UE_N 404). In some aspects of the disclosure, the high-priority message may include at least one command associated with the one or more autonomous UEs. For example, the high-priority message may include a transmit location command to transmit a current location, a release command to initiate a wireless connection release procedure, a preconfigured travel command to travel to a preconfigured location or along a preconfigured path, a safe location command to travel to a location (e.g., safe location coordinates) indicated in the high-priority message, an updated path command to travel along an updated path, a play message command to play at least one of an audio message, a video message, a multimedia message, or a text message, a transmit signal command to transmit at least one of an audio signal, a visual signal or a radio frequency (RF) signal, an altitude change command to change an altitude of the one or more autonomous UEs, an exit area command to travel away from an area, and/or a stop command to stop for one or more types of vehicles.

In some examples, when the high-priority message for autonomous UEs is implemented as a new system information block (SIB) for autonomous UEs, the new SIB for autonomous UEs may include a message identifier parameter, a serial number parameter, and a command parameter. In some examples, the new SIB for autonomous UEs may further include one or more optional parameters, such as a command extension parameter, a command string parameter, a command response parameter, and/or a coordinates parameter.

The base station 408 may broadcast (e.g., transmit) the high-priority message generated at 424. In the example of FIG. 4, the base station 408 may broadcast the high-priority message 426 generated at 424.

The autonomous UE_1 402 may receive the high-priority message 426 and, at 430, the autonomous UE_1 402 may perform the command indicated in the high-priority message 426. The autonomous UE_N 404 may receive the high-priority message 426 and, at 432, the autonomous UE_N 404 may perform the command indicated in the high-priority message 426.

In some aspects of the disclosure, the high-priority message 426 from the base station 408 may further indicate information to be transmitted from an autonomous UE. For example, the high-priority message 426 may indicate that information is to be transmitted in response to the high-priority message 426 or in response to the initiation or completion of a command indicated in the high-priority message 426. In some aspects of the disclosure, the information may include acknowledgement information (e.g., an ACK signal), location information (e.g., the current coordinates of an autonomous UE), or an indication of an initiation or completion of a command. For example, the autonomous UE_1 402 may transmit a response message 434 that includes the information (e.g., acknowledgement information, location information, or an indication of an initiation or completion of the command) indicated in the high-priority message 426.

In some examples, the base station 408 may transmit an update message 436 to the autonomous UE controller 406 in response to the response message 434. For example, if the autonomous UE_1 402 is a UAV under the control of the autonomous UE controller 406 and a flight path of the UAV set by the autonomous UE controller 406 is updated (e.g., changed) by the high-priority message 426, the base station 408 may indicate the updated flight path to the autonomous UE controller 406 via the update message 436.

In some examples, the base station 408 may forward the information in the response message 434 to an autonomous UE management entity or an entity indicated in the response message. For example, if the information in the response message 434 includes an acknowledgment (ACK) to the high-priority message 426, the base station 408 may forward the acknowledgment to the autonomous UE management entity 410. In some examples, the autonomous UE management entity 410 may transmit an indication 440 to the requesting entity 412. For example, the indication 440 may include the acknowledgment from the autonomous UE_1 402 and/or a different indication associated with the command in the request_1 414. For example, if the autonomous UE_1 402 is a UAV and the command in the high-priority message 426 is a command to leave a specified area, the indication 440 may inform the requesting entity 412 as to whether or not the autonomous UE_1 402 has performed the command (e.g., whether or not the autonomous UE_1 402 has left the specified area).

### Notification Message

In some aspects of the present disclosure, the notification message described herein (e.g., the notification message 420 in FIG. 4) may be a short message (also referred to as a broadcast short message) to be broadcast to one or more autonomous UEs. For example, the short message may be transmitted on a Physical Downlink Control Channel (PDCCH) using a Paging Radio Network Temporary Identifier (P-RNTI) with or without an associated paging message using a short message field in Downlink control information (DCI) (e.g., DCI format 1_0). In some examples, the short message may include eight bits. An example bit allocation of the eight bits of the short message is shown in Table 1.

TABLE 1

| Bit | Short Message |
|---|---|
| 1 | systemInfoModification |
| | If set to 1: indication of a BCCH modification other than SIB6, |
| | SIB7 and SIB8 |
| 2 | etwsAndCmasIndication |
| | If set to 1: indication of an ETWS primary notification and/or an |
| | ETWS secondary notification and/or a CMAS notification |
| 3 | stopPagingMonitoring |
| | If set to 1: stop monitoring PDCCH occasion(s) for paging in this |
| | Paging Occasion |
| 4 | AutonomousUEEmergencyBroadcastIndication |
| | If set to 1: indication for Autonomous UEs emergency broadcast |
| | indication |
| 5-8 | Bits 5-8 may be unused and may be ignored by a UE if received |

In Table 1, bit 1 of the short message may represent the most significant bit and bit 8 may represent the least significant bit. As shown in Table 1, bit 1 of the short message may represent a system information modification bit (also referred to as a systemInfoModification bit). If the system information modification bit is set to 1, a broadcast control channel (BCCH) modification other than SIB6, SIB7 and SIB8 is indicated to a UE. For example, SIB6 may contain an ETWS primary notification, SIB7 may contain an ETWS secondary notification, and SIB8 may contain a CMAS notification.

Bit 2 of the short message may represent an ETWS and CMAS indication bit (also referred to as an etwsAndCmasIndication bit). If the ETWS and CMAS indication bit is set to 1, an ETWS primary notification and/or an ETWS secondary notification and/or a CMAS notification is indicated to a UE. Bit 2 may be used to notify high priority (e.g., emergency) messages to UEs associated with a user (e.g., UEs that can act as a smartphone, laptop or tablet). Such messages may be ignored by an autonomous UE.

Bit 3 of the short message may represent a stop paging monitoring bit (also referred to as a stopPagingMonitoring bit). If the stop paging monitoring bit is set to 1, a UE may stop monitoring PDCCH occasion(s) for paging in a current paging occasion.

In the aspects described herein, bit 4 (or possibly bit 5, bit 6, bit 7 or bit 8) of the short message may be used to indicate an initiation and/or notification of a high-priority protocol (e.g., an emergency protocol) for autonomous UEs. For example, bit 4 may represent an autonomous UE emergency broadcast indication bit (also referred to as an AutonomousUEEmergencyBroadcastIndication bit). If the autonomous UE emergency broadcast indication bit (e.g., bit 4) is set to 1, an autonomous UE emergency broadcast may be indicated to an autonomous UE. Autonomous UEs may thus react to the setting of bit 4 by receiving a high priority message, whereas UEs that are not autonomous (e.g., UEs associated with a user) may ignore the high priority message if bit 4 is set to 1.

In some examples, when an autonomous UE is in an idle state (e.g., RRC idle state) or an inactive state (e.g., RRC inactive state) and determines that the autonomous UE emergency broadcast indication bit (e.g., bit 4) is set to 1, the autonomous UE may be triggered to transition to an active state and acquire the new SIB for autonomous UEs described herein. For example, the autonomous UE may acquire the new SIB for autonomous UEs based on scheduling information (also referred to as system information scheduling information or si-SchedulingInfo) for the new SIB for autonomous UEs indicated in a system information block Type 1 (e.g., SIB1).

In some examples, bits 5 through 8 of the short message may be unused and may be ignored by a UE or an autonomous UE if received. Although bit 4 is configured to represent the autonomous UE emergency broadcast indication bit in the short message in the example of Table 1, any one of bits 5 through 8 of the short message may be configured to represent the autonomous UE emergency broadcast indication bit (e.g., instead of bit 4) in other aspects of the disclosure.

### New System Information Block (SIB) for Autonomous UEs

An example of the new SIB for autonomous UEs described herein may be expressed in the Abstract Syntax Notation One (ASN.1) format as follows:

| | |
|---|---|
| newSIB ::= SEQUENCE { | |
| messageIdentifier | BIT STRING (SIZE (16)), |
| serialNumber | BIT STRING (SIZE (16)), |
| Command | OCTET STRING (SIZE(1)) , |
| CommandExtension | OCTECT STRING (SIZE (1)) OPTIONAL, |
| CommandString | OCTET STRING ARRAY OPTIONAL, |
| CommandResponse | BIT STRING (SIZE (8)) OPTIONAL, |
| CommandAreaCoordinatesSeg | OCTET STRING OPTIONAL, |
| lateNonCriticalExtension | OCTET STRING OPTIONAL, |
| ... | |
| } | |

In some aspects of the disclosure, the new SIB for autonomous UEs may include a message identifier parameter (also referred to as a messageIdentifier parameter) that identifies a source and/or type of the high-priority message. In the aspects described herein, the message identifier parameter may be used to indicate a source and/or type of the high-priority message to autonomous UEs. For example, the message identifier parameter may be defined using a bit string of 16 bits. In one example, the bit string may represent a decimal value within the range 4352-6399 for a Public Warning System (PWS) as defined in wireless communication standards (e.g., 5G NR). In some examples, the message identifier parameter may be ‘0001000100000000’ (e.g., 4352 in decimal form) to indicate an earthquake warning message, ‘0001000100000001’ (e.g., 4353 in decimal form) to indicate a tsunami warning message, or ‘0001000100010010’ (e.g., 4370 in decimal form) to indicate a Commercial Mobile Alert System (CMAS) presidential level alert. In some other examples, the message identifier parameter may indicate or imply that a high-priority message (e.g., the new SIB for autonomous UEs) is applicable to only certain types of autonomous UEs (e.g., to a UAV or AV, but not to both) which may enable more precise targeting of a high-priority message and avoid impacts or interference to other types of autonomous UEs that are not targeted.

In some aspects of the disclosure, the new SIB for autonomous UEs may include a serial number parameter (also referred to as a serialNumber parameter) that indicates a serial number of the new SIB for autonomous UEs. For example, the serial number parameter may be defined using a bit string of 16 bits. In some example implementations, the serial number for the new SIB for autonomous UEs may be generated using a counter. In some examples, an autonomous UE that has already decoded a new SIB with a certain serial number may ignore subsequent new SIBs having that certain serial number. Therefore, the serial number parameter may allow autonomous UEs to avoid having to decode duplicate new SIBs.

In some aspects of the disclosure, the new SIB for autonomous UEs may include a command parameter (also referred to as a Command parameter) that indicates a command to be performed by an autonomous UE. In some examples, the command parameter may be defined using octet strings. In one example, the command parameter may be defined using a single octet string (e.g., one byte). In this example, each number (also referred to as a command number) in the range of 1 to 255 may be associated with a different command for autonomous UEs. In some examples, a mapping between each command number and command for autonomous UEs may be provisioned to one or more autonomous UEs via preconfiguration (e.g., as part of UE software code or on a Universal Integrated Circuit Card (UICC)) or in a control message sent to the one or more autonomous UEs (e.g., an earlier SIB message). The command parameter may be set to a number (e.g., in binary form) associated with a particular command. Therefore, if a command associated with the command number 129 is to be indicated to one or more autonomous UEs, the command parameter may be set to the binary value ‘10000001’ to indicate that command.

In some examples, one or more of the commands for autonomous UEs described herein may be for one (e.g., single) type of autonomous UE (e.g., UAVs), for multiple types of autonomous UEs (e.g., UAVs, AVs), or for all types of autonomous UEs (e.g., UAVs, AVs, autonomous CIoT devices, etc.). Therefore, in some aspects of the disclosure, the commands for autonomous UEs may be grouped into different command classes. The different command classes may allow control over the types of autonomous UEs that are to perform a command indicated in the high-priority message described herein.

In one example, a first command class may include a first set of commands for autonomous UEs common to all types of autonomous UEs, a second command class may include a second set of commands for a first type of autonomous UE (e.g., autonomous CIoT devices), a third command class may include a third set of commands for a second type of autonomous UE (e.g., UAVs), and a fourth command class may include a fourth set of commands for a third type of autonomous UE (e.g., AVs). A fifth command class may be designated as a reserved command class.

In some examples, each command class may be associated with a different range of command numbers. For example, the first command class may be associated with a first range of command numbers 1-50, the second command class may be associated with a second range of command numbers 51-100, the third command class may be associated with a third range of command numbers 101-150, the fourth command class may be associated with a fourth range of command numbers 151-200, and the fifth command class may be associated with a fifth range of command numbers 201-255. Continuing with this example, each command in the first command class may be associated with a different command number in a first range of command numbers (e.g., a first range of command numbers 1-50), each command in the second command class may be associated with a different command number in a second range of command numbers (e.g., a second range of command numbers 51-100), each command in the third command class may be associated with a different command number in a third range of command numbers (e.g., a third range of command numbers 101-150), each command in the fourth command class may be associated with a different command number in a fourth range of command numbers (e.g., a fourth range of command numbers 151-200), and each command in the fifth command class be may be associated with a different command number in a fifth range of command numbers (e.g., a fifth range of command numbers 201-255). In other examples, different numbers of groups of commands and/or different ranges of command numbers may be implemented.

In some implementations, an indication of a type (or types) of autonomous UE by the message identifier parameter may be used to override an indication of a type or types of autonomous UE in the command parameter. For example, if the message identifier parameter indicates applicability to UAVs only and if the command parameter indicates applicability to UAVs and AVs, the high-priority message (e.g., the new SIB for autonomous UEs) may be considered by an autonomous UE as applicable only to UAVs. This may be useful to restrict commands that are otherwise applicable to two or more types of autonomous UE to only one type of autonomous UE.

In some aspects of the disclosure, the new SIB for autonomous UEs may include at least the previously described message identifier parameter, serial number parameter, and command parameter. In some aspects of the disclosure, the new SIB for autonomous UEs may further include optional parameters. In some examples, one or more of the optional parameters may be included in the new SIB for autonomous UEs based on the command class of the command indicated in the command parameter.

In some examples, the new SIB for autonomous UEs may optionally include a command extension parameter (also referred to as a CommandExtension parameter) that may serve as an extension to the previously described command parameter for secondary commands. In some examples, the command extension parameter may be defined using an octet string array. In one example, the command extension parameter may be defined using one or more octet strings. In some examples, the command extension parameter may be used to indicate one or more subcommands associated with an indicated command or to indicate a different or additional command for autonomous UEs.

In some examples, the new SIB for autonomous devices may optionally include a command string parameter (also referred to as a CommandString parameter). The command string parameter may be associated with the previously described command parameter. In some examples, the command string parameter may indicate additional information associated with the command indicated in the command parameter. In some examples, the command string parameter may be defined using an octet string array. In one example, the command extension parameter may be defined using a single octet string (e.g., one byte).

In some examples, the new SIB for autonomous UEs may optionally include a command response parameter (also referred to as a CommandResponse parameter). The command response parameter may be associated with the previously described command parameter. In some examples, the command response parameter may indicate whether or not an autonomous UE is to transmit a response message based on the command indicated in the command parameter. The command response parameter may further indicate information to be included in the response message. In some examples, the information may include acknowledgment information (e.g., an ACK signal or value). In some examples, the information may include location information (e.g., the current coordinates of a UAV or AV). In some examples, the information may indicate initiation or completion of the command indicated in the command parameter. The autonomous UE may transmit the response message to the network (e.g., a base station) or an autonomous UE controller. For example, the command response parameter may be defined using a bit string of eight bits.

In some examples, the new SIB for autonomous UEs may optionally include a command area coordinates segment parameter (also referred to as a CommandAreaCoordinatesSeg parameter). The command area coordinates segment parameter may be associated with the previously described command parameter. In some examples, the command area coordinates parameter may be defined using one or more octet strings. In some examples, the command area coordinates segment parameter may indicate a set of coordinates associated with the command indicated in the command parameter. In some examples, the set of coordinates may include Global Positioning System (GPS) coordinates; three dimensional (3D) coordinates; latitude, longitude and optionally altitude coordinates; and/or other types of coordinates. For example, if a command indicated in the command parameter commands UAVs and/or AVs to travel away from an area, the command area coordinates segment parameter may indicate one or more sets of coordinates identifying that area.

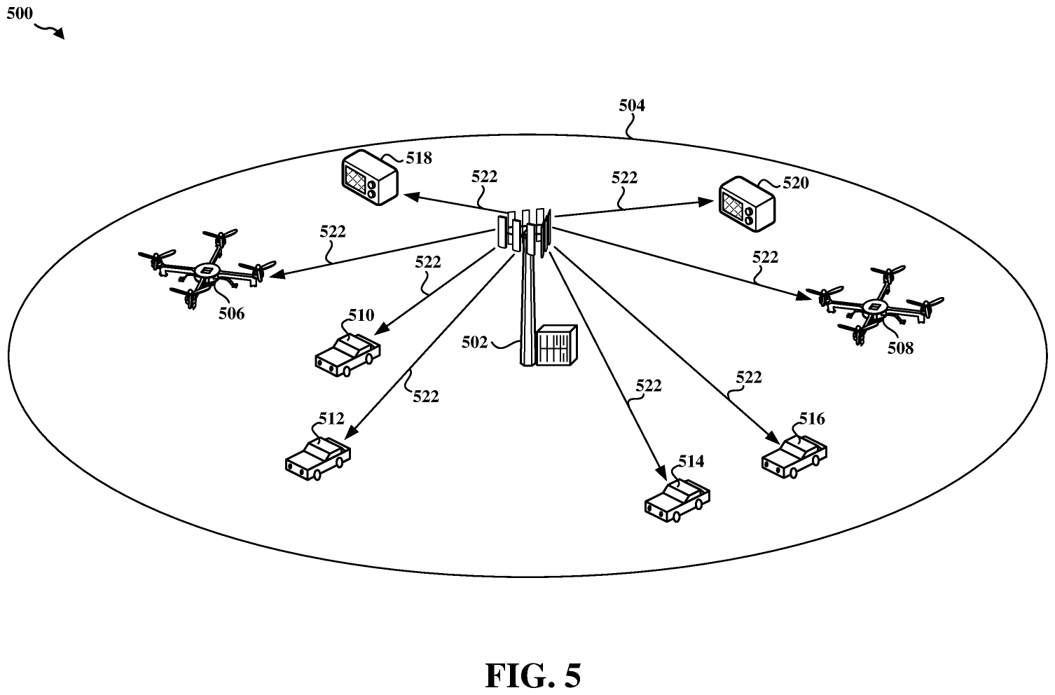

FIG. 5 illustrates an example network 500 including a base station 502 and a number of autonomous UEs in accordance with various aspects of the present disclosure. In FIG. 5, the base station 502 may serve the autonomous UEs 506, 508, 510, 512, 514, 516, 518, 520 within a cell area 504. For example, the autonomous UEs 506, 508 may be UAVs, the autonomous UEs 510, 512, 514, 516 may be AVs, and autonomous UEs 518, 520 may be autonomous CIoT UEs. In one example scenario, with reference to FIG. 5, the autonomous UEs 506, 508 may be implemented as quadcopter UEs, the autonomous UEs 510, 512, 514, 516 may be implemented as autonomous automobiles having UE capabilities, and the autonomous UEs 518, 520 may be implemented as portable autonomous wireless speakers having UE capabilities (also referred to as smart speakers).

In one example scenario, the base station 502 may represent the base station 408 in FIG. 4 and the autonomous UEs in FIG. 5 may represent the number of autonomous UEs in FIG. 4. For example, the autonomous UE_1 402 through the autonomous UE_N 404 in FIG. 4 may include the eight autonomous UEs 506 to 520 shown in FIG. 5 (e.g., N=8).

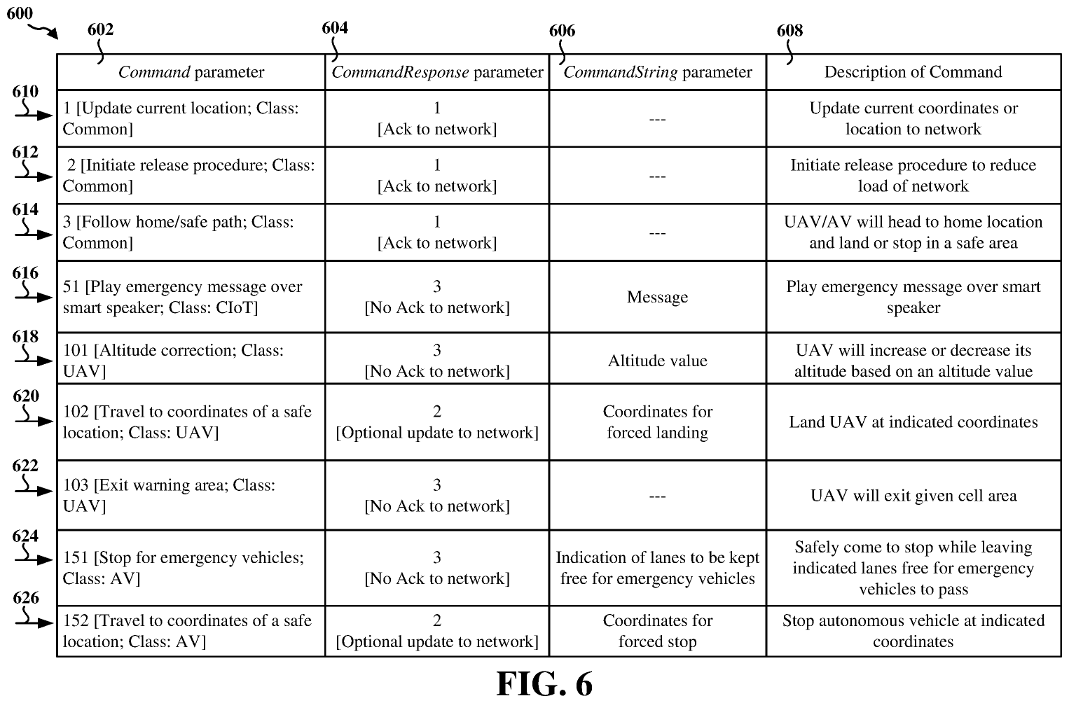

In FIG. 5, the base station 502 may broadcast a high-priority message 522 to the autonomous UEs in or near the cell area 504. In some examples, the high-priority message 522 may be the high-priority message 426 in FIG. 4. In some examples, the high-priority message 522 may be the new SIB for autonomous UEs described herein (e.g., the new SIB for autonomous UEs expressed herein in the ASN.1 format). Example implementations of the high-priority message 522 in FIG. 5 will now be described with reference to FIG. 6 and the new SIB for autonomous UEs expressed herein in the ASN.1 format.

FIG. 6 illustrates a diagram 600 including example parameters and parameter values for a high-priority message in accordance with various aspects of the disclosure. In the diagram 600, each row (e.g., row 610, 612, 614, 616, 618, 620, 622, 624, 626) indicates example values for a command parameter 602, a command response parameter 604, and an optional command string parameter 606 that may be included in a high-priority message for autonomous UEs (e.g., the high-priority message 522). A description 608 of the associated command is also provided in each row. It should be understood that the number and types of parameters indicated in the diagram 600 and the values for the parameters in the diagram 600 are for illustrative purposes to facilitate understanding of the disclosed aspects. Therefore, other aspects of the disclosure may include greater or fewer parameters than those indicated in the diagram 600, different types of parameters, and/or different values for the parameters.

In a first example, with reference to row 610 in the diagram 600, a command parameter in the high-priority message 522 may include a command number 1 (e.g., ‘00000001’ in binary form) associated with a transmit location command to update the current location of an autonomous UE. The command to update the current location of an autonomous UE may be in the first command class (also referred to as a common class) and, therefore, the command to update the current location of an autonomous UE may be for all types of autonomous UEs. For example, any type of autonomous UE that receives the high-priority message 522 with a command parameter including the command number 1 (e.g., ‘00000001’ in binary form) may perform the command to update its current location.

Continuing with the first example, and with further reference to row 610 in the diagram 600, a command response parameter in the high-priority message 522 may include a command response number 1 if a response message is requested from the autonomous UE. In this example, if the autonomous UE determines that the command response parameter includes the command response number 1, the autonomous UE may transmit a response message including its current coordinates or location. In this example, as indicated in row 610, the command string parameter may be omitted from the high-priority message 522.

For example, one or more of the autonomous UEs 506, 508, 510, 512, 514, 516, 518, 520 may transmit a response message including their respective coordinates (e.g., GPS coordinates) to the base station 502. In some examples, the coordinates may include three-dimensional coordinates (e.g., two-dimensional geographic coordinates, such as longitude and latitude values, and an altitude value). For example, the autonomous UE 506 and/or autonomous UE 508 may transmit a message including three-dimensional coordinates.

In a second example, with reference to row 612 in the diagram 600, a command parameter in the high-priority message may include a command number 2 (e.g., ‘00000010’ in binary form) associated with a release command to initiate a release procedure (e.g., a wireless connection release procedure). For example, the command to initiate a release procedure may allow a release of wireless communication resources to reduce the load of the network (e.g., the base station 502). In one use case scenario, the command to initiate a release procedure may be issued to autonomous UEs when the network (e.g., one or more base stations) is congested to ensure network access for high-priority UEs in the network.

The command to initiate a release procedure may be in the first command class (also referred to as a common class) and, therefore, the command to initiate a release procedure may be for all types of autonomous UEs. For example, any type of autonomous UE that receives the high-priority message 522 with a command parameter including a command number 2 (e.g., ‘00000010’ in binary form) may perform the command to initiate a release procedure. For example, one or more of the autonomous UEs 506, 508, 510, 512, 514, 516, 518, 520 may perform the command to initiate a release procedure by releasing radio resources from the base station 502.

Continuing with the second example, and with further reference to row 612 in the diagram 600, a command response parameter in the high-priority message 522 may include a command response number 1 if a response message including an acknowledgement (e.g., ACK) is requested from the autonomous UE in response to the high-priority message 522 or in response to initiating or completing the command (e.g., the command to initiate a release procedure). In this example, as indicated in row 612, the command string parameter may be omitted from the high-priority message 522.

In a third example, with reference to row 614 in the diagram 600, a command parameter in the high-priority message 522 may include a command number 3 (e.g., ‘00000011’ in binary form) associated with a preconfigured travel command to follow a path to a home location, and to land or stop in a safe area. The command to follow a path to a home location, and to land or stop in a safe area may be in the first command class (also referred to as a common class) and, therefore, the command to follow a path to a home location, and to land or stop in a safe area may be for all types of autonomous UEs. For example, any type of autonomous UE that receives the high-priority message 522 with a command parameter including the command number 3 (e.g., ‘00000011’ in binary form) may perform the command to follow a path to a home location, and to land or stop in a safe area.

In some examples, the command to follow a path to a home location, and to land or stop in a safe area may cause one or more of the autonomous UEs capable of self-navigation or self-steering to travel toward a preconfigured location (e.g., a location designated as a home location) or along a preconfigured path, and to land or stop in a safe area. For example, one or more of the autonomous UEs in FIG. 5, such as the autonomous UEs 506, 508, 510, 512, 514, and/or 516, may perform the command by heading to a home location and landing or stopping at a safe area.

Continuing with the third example, and with further reference to row 614 in the diagram 600, a command response parameter in the high-priority message 522 may include a command response number 1 if a response message including an acknowledgement (e.g., ACK) is requested from the autonomous UE in response to receiving the high-priority message 522 or in response to initiating or completing the command (e.g., the command to follow a path to a home location, and to land or stop in a safe area). Therefore, if the autonomous UE determines that the command response parameter includes the command response number 1, the autonomous UE may transmit a response message including an acknowledgement to the network (e.g., the base station 502). In this example, as indicated in row 614, the command string parameter may be omitted from the high-priority message 522.

In a fourth example, with reference to row 616 in the diagram 600, a command parameter in the high-priority message 522 may include a command number 51 (e.g., ‘00110011’ in binary form) associated with a play message command to play an emergency message over a smart speaker. In some examples, the command to play an emergency message over a smart speaker may be in the second command class (also referred to as a CIoT class). Therefore, the command to play an emergency message over a smart speaker may be for a single type of autonomous UE (e.g., an autonomous CIoT UE), such as the autonomous UEs 518, 520 in FIG. 5. Therefore, autonomous CIoT UEs that receive the high-priority message 522 with a command parameter including the command number 51 (e.g., ‘00110011’ in binary form) may perform the command to play an emergency message over a smart speaker. In this example, autonomous UEs different from autonomous CIoT UEs (e.g., autonomous UEs 506, 508, 510, 512, 514, 516) may ignore the high-priority message 522 or may not perform the command to play an emergency message over a smart speaker.

Continuing with the fourth example, and with further reference to row 616 in the diagram 600, a command response parameter in the high-priority message 522 may include a command response number 3 if no response message is requested from the autonomous UE in response to the high-priority message 522 or in response to initiating or completing the command (e.g., the command to play an emergency message over a smart speaker). Therefore, if an autonomous UE determines that the command response parameter includes the number 3, the autonomous UE may not transmit a response message to the network (e.g., the base station 502).

In this example, as indicated in row 616, the command string parameter may include at least a portion of the message to be played over the smart speaker. For example, the message may be a voice message announcing an emergency, such as an impending tsunami, a fire in a nearby location, or other types of high-priority warnings.

In some implementations, with reference to row 616 in the diagram 600, a command parameter in the high-priority message 522 with command number 51 may be used in addition or instead to cause an autonomous UE to provide some indication of presence and/or information to nearby people and/or other devices or entities. The indication of presence and/or information may include flashing of lights and/or sounding of a horn by an autonomous UE that is an AV; or flashing of a light, sounding of an audio alarm (e.g., a high pitched “beep”) and/or transmission of an easily detectable RF signal by an autonomous UE that is a UAV. Parameters associated with the indication of presence and/or information (e.g., duration of provision and/or frequency and content of an RF transmission) can be included in the command string parameter.

In a fifth example, with reference to row 618 in the diagram 600, a command parameter in the high-priority message 522 may include a command number 101 (e.g., ‘01100101’ in binary form) associated with an altitude change command to correct an altitude of an autonomous UE. In some examples, the command to correct an altitude of an autonomous UE may be in the third command class (also referred to as a UAV class). Therefore, the command to correct an altitude of an autonomous UE may be for a single type of autonomous UE (e.g., a UAV device), such as the autonomous UEs 506, 508 in FIG. 5.

UAV devices that receive the high-priority message 522 with a command parameter including the command number 101 (e.g., ‘01100101’ in binary form) may perform the command to correct an altitude of an autonomous UE. In this example, autonomous UEs different from UAV devices (e.g., autonomous UEs 510, 512, 514, 516, 518, 520) may ignore the high-priority message 522 or may not perform the command to correct an altitude of an autonomous UE. Therefore, when the autonomous UEs 506, 508 receive the high-priority message 522 with a command parameter including the command number 101 (e.g., ‘01100101’ in binary form), the autonomous UEs 506, 508 may perform the command by increasing or decreasing their respective altitudes based on an altitude value.

Continuing with the fifth example, and with further reference to row 618 in the diagram 600, a command response parameter in the high-priority message 522 may include a command response number 3 if no response message is requested from the autonomous UE in response to the high-priority message 522 or in response to initiating or completing the command (e.g., the command to correct an altitude of an autonomous UE). Therefore, if the autonomous UE determines that the command response parameter includes the command response number 3, the autonomous UE may not transmit a response message to the network (e.g., the base station 502). In this example, as indicated in row 618, the command string parameter may include the altitude value. For example, the altitude value may be indicated as a number (e.g., in binary form) in units of feet or meters.

In a sixth example, with reference to row 620 in the diagram 600, a command parameter in the high-priority message 522 may include a command number 102 (e.g., ‘01100110’ in binary form) associated with a safe location landing command to travel to coordinates of a safe location. In some examples, the command to travel to coordinates of a safe location may be in the third command class (also referred to as a UAV class). Therefore, the command to travel to coordinates of a safe location may be for a single type of autonomous UE (e.g., a UAV device), such as the autonomous UEs 506, 508 in FIG. 5.

For example, when the autonomous UEs 506, 508 receive the high-priority message 522 with a command parameter including the command number 102 (e.g., ‘01100110’ in binary form), the autonomous UEs 506, 508 may perform the command by landing at indicated coordinates. In this example, autonomous UEs different from UAV devices (e.g., autonomous UEs 510, 512, 514, 516, 518, 520) may ignore the high-priority message 522 or may not perform the command to travel to coordinates of a safe location.

Continuing with the sixth example, and with further reference to row 620 in the diagram 600, a command response parameter in the high-priority message 522 may include a command response number 2 if a response message from the autonomous UE is optional. Therefore, if an autonomous UE determines that the command response parameter includes the command response number 2, the autonomous UE may or may not transmit a response message to the network (e.g., the base station 502). In this example, as indicated in row 620, the command string parameter may include coordinates (also referred to as safe coordinates), such as GPS coordinates, for a forced landing of an autonomous UE.

In a seventh example, with reference to row 622 in the diagram 600, a command parameter in the high-priority message 522 may include a command number 103 (e.g., ‘01100111’ in binary form) associated with an exit area command to exit a warning area. In some examples, the command to exit a warning area may be in the third command class (also referred to as a UAV class). Therefore, the command to exit a warning area may be for a single type of autonomous UE (e.g., a UAV device), such as the autonomous UEs 506, 508 in FIG. 5.

For example, when the autonomous UEs 506, 508 receive the high-priority message 522 with a command parameter including the command number 103 (e.g., ‘01100111’ in binary form), the autonomous UEs 506, 508 may perform the command by exiting a given cell area (e.g., the cell area 504). In this example, autonomous UEs different from a UAV device (e.g., autonomous UEs 510, 512, 514, 516, 518, 520) may ignore the high-priority message 522 or may not perform the command to exit a given cell area.

Continuing with the seventh example, and with further reference to row 622 in the diagram 600, a command response parameter in the high-priority message 522 may include a command response number 3 if no response message is requested from the autonomous UE in response to the high-priority message 522 or in response to initiating or completing the command (e.g., the command to exit a warning area). Therefore, if an autonomous UE determines that the command response parameter includes the command response number 3, the autonomous UE may not transmit a response message to the network (e.g., the base station 502). In this example, as indicated in row 622, the command string parameter may be omitted from the high-priority message 522.

In an eighth example, with reference to row 624 in the diagram 600, a command parameter in the high-priority message 522 may include a command number 151 (e.g., ‘10010111’ in binary form) associated with a stop command to stop for emergency vehicles. In some examples, the command to stop for emergency vehicles may be in the fourth command class (also referred to as an AV class). Therefore, the command to stop for emergency vehicles may be for a single type of autonomous UE (e.g., an AVs), such as the autonomous UEs 510, 512, 514, 516 in FIG. 5.

For example, when the autonomous UEs 510, 512, 514, 516 receive the high-priority message 522 with a command parameter including the command number 151 (e.g., ‘10010111’ in binary form), the autonomous UEs 510, 512, 514, 516 may perform the command by safely coming to a stop while leaving indicated lanes (e.g., lanes of a road) free for emergency vehicles to pass. In some examples, the autonomous UE may stop at a shoulder (e.g., a breakdown lane) or outside of one or more lanes that may be used by emergency vehicles. In this example, autonomous UEs different from AVs (e.g., autonomous UEs 506, 508, 518, 520) may ignore the high-priority message 522 or may not perform the command to stop for emergency vehicles.

Continuing with the eighth example, and with further reference to row 624 in the diagram 600, a command response parameter in the high-priority message 522 may include a command response number 3 if no response message is requested from the autonomous UE in response to the high-priority message 522 or in response to completing the command (e.g., the command to stop for emergency vehicles). Therefore, if an autonomous UE determines that the command response parameter includes the command response number 3, the autonomous UE may not transmit a response message to the network (e.g., the base station 502).

In this example, as indicated in row 624 in the diagram 600, the command string parameter may include an indication of lanes to be kept free for emergency vehicles. For example, the indication may be a sequence of bits mapped to lanes of a road. In this example, a four lane road may be represented as a sequence of four bits, where the least significant bit represents the rightmost lane. Each lane to be kept free for emergency vehicles may be set to ‘1’ in the sequence of four bits. Therefore, if the two rightmost lanes of the four lane road are to be kept free for emergency vehicles, the command string parameter may include the value ‘0011’.

In a ninth example, with reference to row 626 in the diagram 600, a command parameter in the high-priority message 522 may include a command number 152 (e.g., ‘10011000’ in binary form) associated with a safe location stop command to travel to coordinates of a safe location and stop. In some examples, the command to travel to coordinates of a safe location may be in the fourth command class (also referred to as an AV class). Therefore, the command to travel to coordinates of a safe location may be for a single type of autonomous UE (e.g., an AV), such as the autonomous UEs 510, 512, 514, 516 in FIG. 5.

For example, when the autonomous UEs 510, 512, 514, 516 receive the high-priority message 522 with a command parameter including the command number 152 (e.g., ‘10011000’ in binary form), the autonomous UEs 510, 512, 514, 516 may perform the command by stopping at indicated coordinates (also referred to as safe coordinates). In this example, autonomous UEs different from AVs (e.g., autonomous UEs 506, 508, 518, 520) may ignore the high-priority message 522 or may not perform the command to travel to coordinates of a safe location.

Continuing with the ninth example, and with further reference to row 626 in the diagram 600, a command response parameter in the high-priority message 522 may include a command response number 2 if a response message from the autonomous UE is optional. Therefore, if an autonomous UE determines that the command response parameter includes the command response number 2, the autonomous UE may or may not transmit a response message to the network (e.g., the base station 502). In this example, as indicated in row 626, the command string parameter may include coordinates (also referred to as safe coordinates), such as GPS coordinates, at which an autonomous UE is to stop.

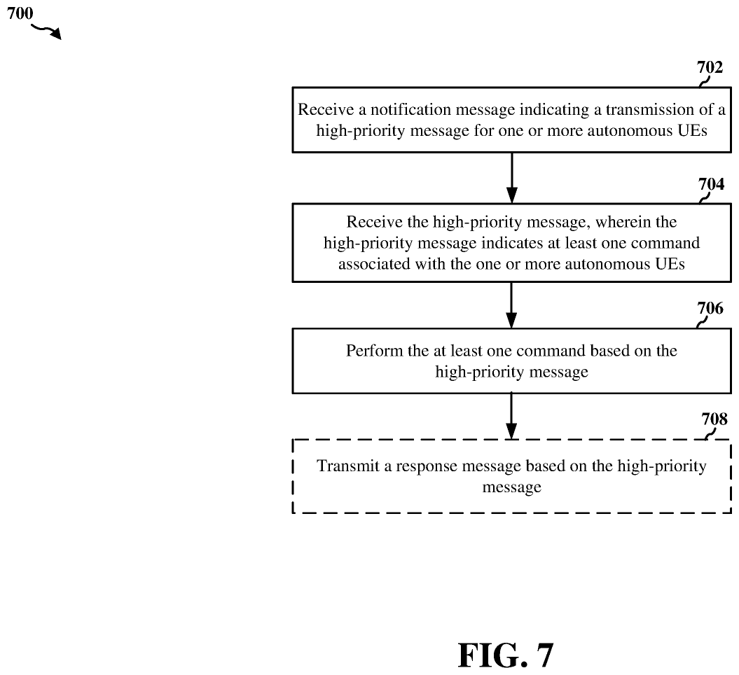

FIG. 7 is a flowchart 700 of a method of wireless communication. The method may be performed by an autonomous UE (e.g., the autonomous UE 104, 402, 404, 506, 508, 510, 512, 514, 516, 518, 520; the apparatus 802/802′; the processing system 914, which may include the memory 360 and which may be the entire autonomous UE 104, 402, 404, 506, 508, 510, 512, 514, 516, 518, 520 or a component of the autonomous UE 104, 402, 404, 506, 508, 510, 512, 514, 516, 518, 520, such as the TX processor 368, the RX processor 356, and/or the controller/processor 359). In FIG. 7, operations indicated with dashed lines represent optional operations.

At 702, the autonomous UE receives a notification message indicating a transmission of a high-priority message for one or more autonomous UEs. In some examples, the notification message may be a broadcast short message as described with reference to Table 1. For example, the broadcast short message may include eight bits, and the transmission of the high-priority message may be indicated in a fourth bit, a fifth bit, a sixth bit, a seventh bit, or an eighth bit of the broadcast short message. In some examples, the notification message may be the notification message 420. In some examples, the transmission of the high-priority message may be indicated in more than one of the fourth bit, the fifth bit, the sixth bit, the seventh bit, and the eighth bit of the broadcast short message.

At 704, the autonomous UE receives the high-priority message, wherein the high-priority message indicates at least one command associated with the one or more autonomous UEs. For example, the high-priority message may be the high-priority message 426 described herein with reference to FIG. 4 or the high-priority message 522 described herein with reference to FIG. 5.

In some aspects of the disclosure, the high-priority message may be a system information block (SIB), such as the new SIB for autonomous devices described herein. For example, the new SIB for autonomous devices may include at least one of a message identifier parameter, a serial number parameter, a command parameter, a command extension parameter, a command string parameter, a command response parameter, or a coordinates parameter.

In some examples, the at least one command associated with the one or more autonomous UEs includes a transmit location command to transmit a current location, a release command to initiate a wireless connection release procedure, a preconfigured travel command to travel to a preconfigured location or along a preconfigured path, a safe location command to travel to a location indicated in the high-priority message, an updated path command to travel along an updated path, a play message command to play at least one of an audio message, a video message, a multimedia message, or a text message, a transmit signal command to transmit at least one of an audio signal, a visual signal or a radio frequency (RF) signal, an altitude change command to change an altitude of the one or more autonomous UEs, an exit area command to travel away from an area, and/or a stop command to stop for one or more types of vehicles (e.g., emergency vehicles, such as an ambulance, fire department vehicle, police vehicle, etc.).

In some examples, at least a portion of the audio message, the video message, the multimedia message, the text message, the audio signal, the visual signal, the RF signal, a value of the altitude, or the updated path, is included in the high-priority message. In some examples, the location indicated in the high-priority message includes a set of coordinates.

In some aspects of the disclosure, the at least one command is included in one of a plurality of command classes, wherein each of the plurality of command classes includes a set of commands for a single autonomous UE type (e.g., UAVs), multiple autonomous UE types (e.g., UAVs and AVs), or all autonomous UE types (e.g., UAV, AV, autonomous CIoT, etc.). In one example, a first command class may include a first set of commands for autonomous UEs common to all types of autonomous UEs, a second command class may include a second set of commands for a first type of autonomous UE (e.g., autonomous CIoT devices), a third command class may include a third set of commands for a second type of autonomous UE (e.g., UAVs), and a fourth command class may include a fourth set of commands for a third type of autonomous UE (e.g., AVs). In another example, a command class may include a set of commands for multiple autonomous UE types (e.g., UAVs and AVs).

In some aspects of the disclosure, the message identifier parameter may indicate that the high-priority message is intended only for a certain type (or types) of autonomous UE, such as a UAV only or an AV only. In these aspects, the indication of a type (or types) of autonomous UE in the message identifier parameter may override an indication of a type (or types) of autonomous UE in the command parameter.

At 706, the autonomous UE performs the at least one command based on the high-priority message. For example, with reference to FIG. 4, the autonomous UE_1 402 at 430 may perform the command indicated in the high-priority message 426. The autonomous UE_N 404 at 432 may perform the command indicated in the high-priority message 430.

Finally, at 708, the UE may optionally transmit a response message based on the high-priority message. In some examples, the high-priority message further indicates information to be transmitted from the one or more autonomous UEs in response to the high-priority message or in response to an initiation or completion of the at least one command. The information to be transmitted may include acknowledgement information (e.g., an ACK), location information (e.g., GPS coordinates, three-dimensional coordinates, etc.), or an indication of an initiation or completion of the command. The response message may include the information.

For example, the high-priority message 426 from the base station 408 may further indicate information to be transmitted from an autonomous UE. For example, the high-priority message 426 may indicate that information is to be transmitted in response to the high-priority message 426 or in response to the initiation or completion of a command indicated in the high-priority message 426. In some aspects of the disclosure, the information may include acknowledgement information (e.g., an ACK signal), location information (e.g., the current coordinates of an autonomous UE), or an indication of an initiation or completion of a command. For example, the autonomous UE_1 402 may transmit a response message 434 that includes the information (e.g., acknowledgement information, location information, or an indication of an initiation or completion of the command) indicated in the high-priority message 426.

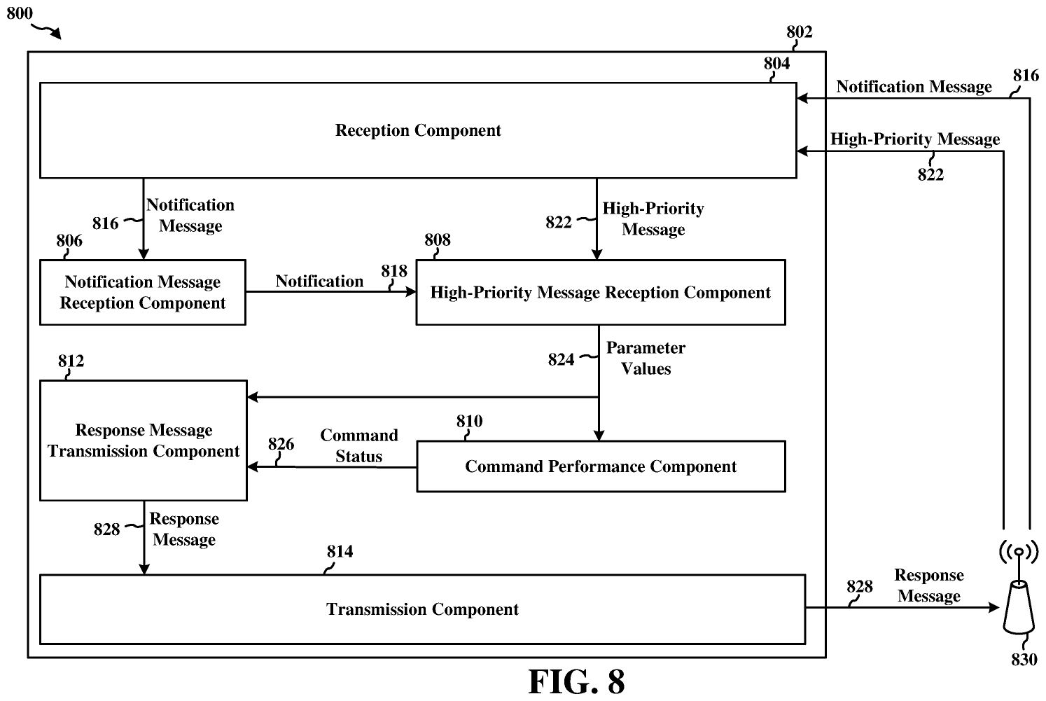

FIG. 8 is a conceptual data flow diagram 800 illustrating the data flow between different means/components in an example apparatus 802. The apparatus may be an autonomous UE. The apparatus includes a reception component 804 that receives messages (e.g., downlink messages, broadcast messages) from the base station 830. For example, the messages may include a notification message 816 and a high-priority message 822.

The apparatus further includes a notification message reception component 806 that receives the notification message 816 (e.g., via the reception component 804) indicating a transmission of a high-priority message for one or more autonomous UEs.

The apparatus further includes a high-priority message reception component 808 that receives the high-priority message 822 (e.g., via the reception component 804). The high-priority message indicates at least one command associated with the one or more autonomous UEs. In some examples, the high-priority message reception component 808 may receive a notification 818 from the notification message reception component 806 when the notification message 816 is received. The high-priority message reception component 808 may detect the high-priority message 822 based on the notification 818.

The apparatus further includes a command performance component 810 that performs the at least one command based on the high-priority message 822. In some examples, the command performance component 810 may receive parameter values 824 included in the high-priority message 822 from the high-priority message reception component 808. In some examples, the parameter values 824 may include values of a message identifier parameter, a serial number parameter, a command parameter, a command extension parameter, a command string parameter, a command response parameter, and/or a coordinates parameter.

The apparatus further includes a response message transmission component 812 that transmits a response message 828 based on the high-priority message 822. For example, when the high-priority message 822 indicates information to be transmitted from the apparatus, the response message transmission component 812 may transmit (e.g., via the transmission component 814) a response message 828 including the information in response to the high-priority message 822 or in response to an initiation or completion of the at least one command. In some examples, the response message transmission component 812 may receive a command status message 826 from the command performance component 810 indicating whether or not the at least one command has been initiated or completed. In some examples, the response message transmission component 812 may receive one or more of the parameter values 824 (e.g., a command response parameter value) from the high-priority message reception component 808.

The apparatus further includes a transmission component 814 that transmits uplink messages to the base station 830. In some examples, the transmission component 814 may transmit the response message 828 to the base station 830.

The apparatus may include additional components that perform each of the blocks of the algorithm in the aforementioned flowchart of FIG. 7. As such, each block in the aforementioned flowchart of FIG. 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

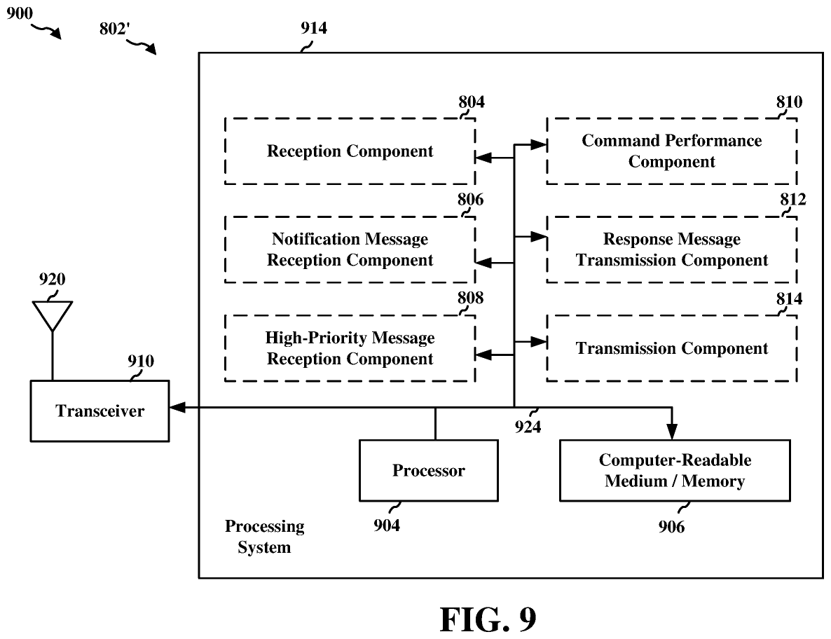

FIG. 9 is a diagram 900 illustrating an example of a hardware implementation for an apparatus 802′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware components, represented by the processor 904, the components 804, 806, 808, 810, 812, 814, and the computer-readable medium/memory 906. The bus 924 may also link various other circuits such as timing sources, peripherals, voltage regulators, and power management circuits, which are well known in the art, and therefore, will not be described any further.

The processing system 914 may be coupled to a transceiver 910. The transceiver 910 is coupled to one or more antennas 920. The transceiver 910 provides a means for communicating with various other apparatus over a transmission medium. The transceiver 910 receives a signal from the one or more antennas 920, extracts information from the received signal, and provides the extracted information to the processing system 914, specifically the reception component 804. In addition, the transceiver 910 receives information from the processing system 914, specifically the transmission component 814, and based on the received information, generates a signal to be applied to the one or more antennas 920. The processing system 914 includes a processor 904 coupled to a computer-readable medium/memory 906. The processor 904 is responsible for general processing, including the execution of software stored on the computer-readable medium/memory 906. The software, when executed by the processor 904, causes the processing system 914 to perform the various functions described supra for any particular apparatus. The computer-readable medium/memory 906 may also be used for storing data that is manipulated by the processor 904 when executing software. The processing system 914 further includes at least one of the components 804, 806, 808, 810, 812, 814. The components may be software components running in the processor 904, resident/stored in the computer readable medium/memory 906, one or more hardware components coupled to the processor 904, or some combination thereof. The processing system 914 may be a component of the UE 350 described herein with respect of FIG. 3 and may include the memory 360 and/or at least one of the TX processor 368, the RX processor 356, and the controller/processor 359. Alternatively, the processing system 914 may be the entire UE (e.g., see UE 350 of FIG. 3).

In one configuration, the apparatus 802/802′ for wireless communication includes means for receiving a notification message indicating a transmission of a high-priority message for one or more autonomous user equipments (UEs), means for receiving the high-priority message, wherein the high-priority message indicates at least one command associated with the one or more autonomous UEs, means for performing the at least one command based on the high-priority message, and means for transmitting a response message based on the high-priority message. The aforementioned means may be one or more of the aforementioned components of the apparatus 802 and/or the processing system 914 of the apparatus 802′ configured to perform the functions recited by the aforementioned means. As described supra, the processing system 914 may include the TX Processor 368, the RX Processor 356, and the controller/processor 359 described herein with respect of FIG. 3. As such, in one configuration, the aforementioned means may be the TX Processor 368, the RX Processor 356, and the controller/processor 359 configured to perform the functions recited by the aforementioned means.

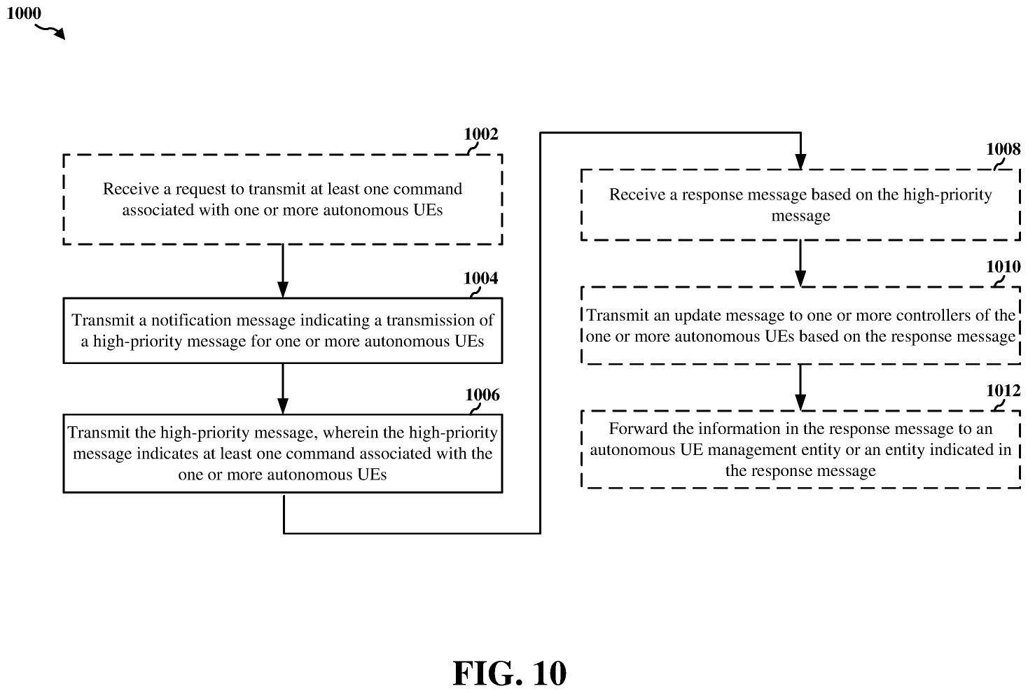

FIG. 10 is a flowchart 1000 of a method of wireless communication. The method may be performed by a base station (e.g., the base station 102, 408, 502; the apparatus 1102/1102′; the processing system 1214, which may include the memory 376 and which may be the entire base station 102, 408, 502 or a component of the base station 102, 408, 502, such as the TX processor 316, the RX processor 370, and/or the controller/processor 375). In FIG. 10, operations indicated with dashed lines represent optional operations.

At 1002, the base station receives a request to transmit at least one command associated with one or more autonomous UEs. For example, with reference to FIG. 4, the base station 408 may receive the request_2 416 including a request to broadcast a high-priority message (e.g., the high-priority message 426) to autonomous UEs. In some examples, the request_2 416 may indicate one or more commands for the one or more autonomous UEs. In some examples, the request_2 416 may further indicate information (e.g., emergency information) to be distributed to the one or more autonomous UEs. For example, the one or more commands and/or information to be distributed to the autonomous UEs may be associated with the previously described Public Warning Systems (PWS), which may include the Commercial Mobile Alert System (CMAS), the Earthquake and Tsunami Warning System (ETWS), and/or other such systems.

In some examples, the at least one command associated with the one or more autonomous UEs includes a transmit location command to transmit a current location, a release command to initiate a wireless connection release procedure, a preconfigured travel command to travel to a preconfigured location or along a preconfigured path, a safe location command to travel to a location indicated in the high-priority message, an updated path command to travel along an updated path, a play message command to play at least one of an audio message, a video message, a multimedia message, or a text message, a transmit signal command to transmit at least one of an audio signal, a visual signal or a radio frequency (RF) signal, an altitude change command to change an altitude of the one or more autonomous UEs, an exit area command to travel away from an area, and/or a stop command to stop for one or more types of vehicles.

At 1004, the base station transmits a notification message indicating a transmission of a high-priority message for one or more autonomous UEs. In some examples, the notification message may be a broadcast short message as described with reference to Table 1. For example, the broadcast short message may include eight bits, and the transmission of the high-priority message may be indicated in a fourth bit, a fifth bit, a sixth bit, a seventh bit, or an eighth bit of the broadcast short message. In some examples, the notification message may be the notification message 420.

At 1006, the base station transmits the high-priority message, wherein the high-priority message indicates at least one command associated with the one or more autonomous UEs. In some aspects of the disclosure, the base station transmits the notification message and the high-priority message in response to the request (e.g., the request_2 416). For example, the high-priority message may be the high-priority message 426 described herein with reference to FIG. 4 or the high-priority message 522 described herein with reference to FIG. 5.

In some aspects of the disclosure, the high-priority message may be a system information block (SIB), such as the new SIB for autonomous devices described herein. For example, the new SIB for autonomous devices may include at least one of a message identifier parameter, a serial number parameter, a command parameter, a command extension parameter, a command string parameter, a command response parameter, or a coordinates parameter.

In some examples, the at least one command associated with the one or more autonomous UEs includes a transmit location command to transmit a current location, a release command to initiate a wireless connection release procedure, a preconfigured travel command to travel to a preconfigured location or along a preconfigured path, a safe location command to travel to a location indicated in the high-priority message, an updated path command to travel along an updated path, a play message command to play at least one of an audio message, a video message, a multimedia message, or a text message, a transmit signal command to transmit at least one of an audio signal, a visual signal or a radio frequency (RF) signal, an altitude change command to change an altitude of the one or more autonomous UEs, an exit area command to travel away from an area, and/or a stop command to stop for one or more types of vehicles (e.g., emergency vehicles, such as an ambulance, fire department vehicle, police vehicle, etc.).

In some examples, at least a portion of the audio message, the video message, the multimedia message, the text message, the audio signal, the visual signal, the RF signal, a value of the altitude, or the updated path, is included in the high-priority message. In some examples, the location indicated in the high-priority message includes a set of coordinates.

In some aspects of the disclosure, the at least one command is included in one of a plurality of command classes, wherein each of the plurality of command classes includes a set of commands for a single autonomous UE type (e.g., UAVs), multiple autonomous UE types (e.g., UAVs and AVs), or all autonomous UE types (e.g., UAV, AV, autonomous CIoT, etc.). In one example, a first command class may include a first set of commands for autonomous UEs common to all types of autonomous UEs, a second command class may include a second set of commands for a first type of autonomous UE (e.g., autonomous CIoT devices), a third command class may include a third set of commands for a second type of autonomous UE (e.g., UAVs), and a fourth command class may include a fourth set of commands for a third type of autonomous UE (e.g., AVs). In another example, a command class may include a set of commands for multiple autonomous UE types (e.g., UAVs and AVs).

At 1008, the base station receives a response message based on the high-priority message. In some examples, the high-priority message further indicates information to be transmitted from the one or more autonomous UEs in response to the high-priority message or in response to an initiation or completion of the at least one command. The information to be transmitted may include acknowledgement information (e.g., an ACK), location information (e.g., GPS coordinates, three-dimensional coordinates, etc.), or an indication of an initiation or completion of the at least one command. The response message may include the information.

For example, the high-priority message 426 from the base station 408 may further indicate information to be transmitted from an autonomous UE. For example, the high-priority message 426 may indicate that information is to be transmitted in response to the high-priority message 426 or in response to the initiation or completion of a command indicated in the high-priority message 426. In some aspects of the disclosure, the information may include acknowledgement information (e.g., an ACK signal), location information (e.g., the current coordinates of an autonomous UE), or an indication of an initiation or completion of a command. For example, the autonomous UE_1 402 may transmit a response message 434 that includes the information (e.g., acknowledgement information, location information, or an indication of an initiation or completion of the command) indicated in the high-priority message 426.

At 1010, the base station transmits an update message to one or more controllers of the one or more autonomous UEs based on the response message. For example, with reference to FIG. 4, the base station 408 may transmit an update message 436 to the autonomous UE controller 406 in response to the response message 434. For example, if the autonomous UE_1 402 is a UAV under the control of the autonomous UE controller 406 and a flight path of the UAV set by the autonomous UE controller 406 is updated (e.g., changed) by the high-priority message 426, the base station 408 may indicate the updated flight path to the autonomous UE controller 406 via the update message 436.

Finally, at 1012, the base station forwards the information in the response message to an autonomous UE management entity or an entity indicated in the response message. For example, with reference to FIG. 4, if the information in the response message 434 includes an acknowledgment (ACK) to the high-priority message 426, the base station 408 may forward the acknowledgment to the autonomous UE management entity 410.

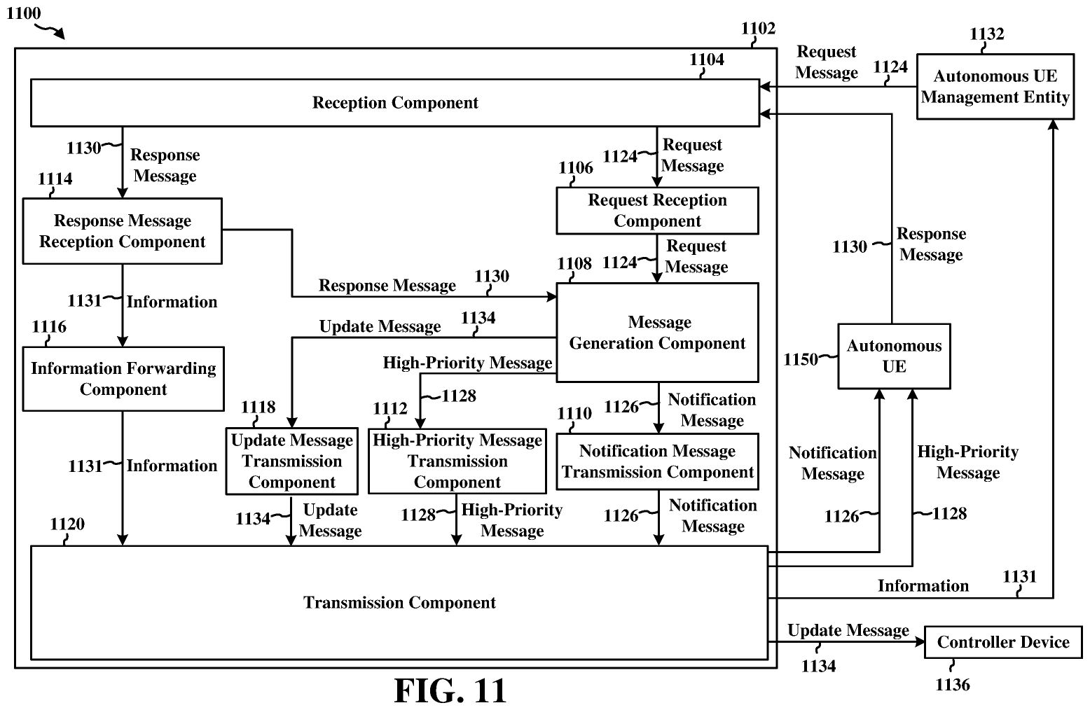

FIG. 11 is a conceptual data flow diagram 1100 illustrating the data flow between different means/components in an example apparatus 1102. The apparatus may be a base station.

The apparatus includes a reception component 1104 that receives messages from one or more network entities (e.g., an autonomous UE management entity 1132) and autonomous UEs (e.g., autonomous UE 1150). For example, the messages may include a request message 1124 and a response message 1130.

The apparatus further includes a request reception component 1106 that receives a request (e.g., a request in the request message 1124) to transmit at least one command associated with one or more autonomous UEs. The request message 1124 may be received from the autonomous UE management entity 1132 via the reception component 1104. In some examples, the request message 1124 may be received from the autonomous UE management entity 1132 in response to a request from a requesting entity (e.g., an authorized third party).

The apparatus further includes a message generation component 1108 that generates a notification message 1126, a high-priority message 1128, and an update message 1134. In some examples, the message generation component 1108 generates the notification message 1126 and the high-priority message 1128 based on the request message 1124 from the request reception component 1106. The notification message 1126 indicates a transmission of the high-priority message 1128 for one or more autonomous UEs (e.g., the autonomous UE 1150). The high-priority message 1128 indicates at least one command associated with the one or more autonomous UEs. The update message updates one or more controllers of the one or more autonomous UEs based on a response message 1130 (e.g., based on information included in the response message 1130) from the one or more autonomous UEs (e.g., the autonomous UE 1150).

The apparatus further includes a notification message transmission component 1110 that transmits (e.g., via the transmission component 1120) the notification message 1126. The apparatus further includes a high-priority message transmission component 1112 that transmits (e.g., via the transmission component 1120) the high-priority message 1128. In some examples, the notification message 1126 and the high-priority message 1128 are generated and transmitted in response to the request in the request message 1124. The apparatus further includes an update message transmission component that transmits (e.g., via the transmission component 1120) the update message 1134 to a controller device 1136. For example, the controller device 1136 may be a handler or controller of the one or more autonomous UEs (e.g., the autonomous UE 1150) based on the response message 1130.

The apparatus further includes a response message reception component 1114 that receives a response message 1130 from the one or more autonomous UEs (e.g., autonomous UE 1150) in response to the high-priority message 1128 or in response to a completion of the at least one command. For example, when the high-priority message 1128 further indicates information to be transmitted from the one or more autonomous UEs, the response message 1130 may include the indicated information (e.g., the information 1131).

The apparatus further includes an information forwarding component 1116 that forwards (e.g., via the transmission component 1120) the information 1131 in the response message 1130 to the autonomous UE management entity 1132 or an entity indicated in the response message 1130.

The apparatus may include additional components that perform each of the blocks of the algorithm in the aforementioned flowchart of FIG. 10. As such, each block in the aforementioned flowchart of FIG. 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

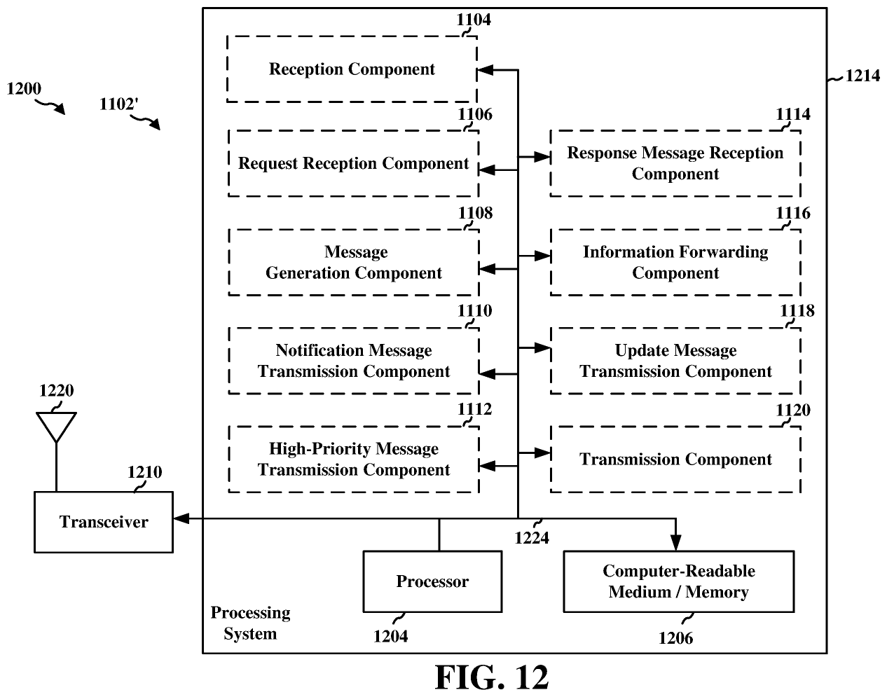

FIG. 12 is a diagram 1200 illustrating an example of a hardware implementation for an apparatus 1102′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware components, represented by the processor 1204, the components 1104, 1106, 1108, 1110, 1112, 1114, 1116, 1118, 1120, and the computer-readable medium/memory 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The transceiver 1210 receives a signal from the one or more antennas 1220, extracts information from the received signal, and provides the extracted information to the processing system 1214, specifically the reception component 1104. In addition, the transceiver 1210 receives information from the processing system 1214, specifically the transmission component 1120, and based on the received information, generates a signal to be applied to the one or more antennas 1220. The processing system 1214 includes a processor 1204 coupled to a computer-readable medium/memory 1206. The processor 1204 is responsible for general processing, including the execution of software stored on the computer-readable medium/memory 1206. The software, when executed by the processor 1204, causes the processing system 1214 to perform the various functions described supra for any particular apparatus. The computer-readable medium/memory 1206 may also be used for storing data that is manipulated by the processor 1204 when executing software. The processing system 1214 further includes at least one of the components 1104, 1106, 1108, 1110, 1112, 1114, 1116, 1118, 1120. The components may be software components running in the processor 1204, resident/stored in the computer readable medium/memory 1206, one or more hardware components coupled to the processor 1204, or some combination thereof. The processing system 1214 may be a component of the base station 310 and may include the memory 376 and/or at least one of the TX processor 316, the RX processor 370, and the controller/processor 375. Alternatively, the processing system 1214 may be the entire base station (e.g., see base station 310 of FIG. 3).

In one configuration, the apparatus 1102/1102′ for wireless communication includes means for transmitting a notification message indicating a transmission of a high-priority message for one or more autonomous user equipments (UEs), means for transmitting the high-priority message, wherein the high-priority message indicates at least one command associated with the one or more autonomous UEs, means for receiving a request to transmit the at least one command associated with the one or more autonomous UEs, wherein the notification message and the high-priority message are transmitted in response to the request, means for receiving a response message from the one or more autonomous UEs based on the high-priority message, means for forwarding the information in the response message to an autonomous UE management entity or an entity indicated in the response message, and means for transmitting an update message to one or more controllers of the one or more autonomous UEs based on the response message.

The aforementioned means may be one or more of the aforementioned components of the apparatus 1102 and/or the processing system 1214 of the apparatus 1102′ configured to perform the functions recited by the aforementioned means. As described supra, the processing system 1214 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

Therefore, the aspects described herein allow autonomous UEs in a wireless communication network (e.g., a 5G NR network) to receive a broadcast of a high-priority message without impacting or modifying the functionality of other UEs (e.g., non-autonomous UEs) in the wireless communication network. As described herein, the high-priority message may include one or more commands that may be performed by the autonomous UEs.

In some example scenarios, the one or more commands may allow the autonomous UEs to support emergency services, such as a command to bring one or more autonomous UEs (e.g., AVs) to a stop while leaving certain lanes free for emergency vehicles to pass or a command to cause one or more autonomous UEs (e.g., UAVs) to land in a safe area to clear an airspace. In other example scenarios, the one or more commands may allow the autonomous UEs to distribute emergency messages (e.g., by playing at least one of an audio message, a video message, a multimedia message, or a text message) to users of the autonomous UEs and/or people proximate to the autonomous UEs.

The aspects described herein may be efficiently implemented in existing wireless communication systems (e.g., 5G NR networks). For example, the notification message (e.g., notification message 420 in FIG. 4) described herein may be implemented using an unused bit in a short message as described with reference to Table 1. Moreover, the high-priority messages described herein utilize a flexible structure to provide support for new commands and/or parameters for autonomous devices as needed. For example, when the high-priority messages are implemented using the new SIB for autonomous UEs as described herein, one or more of the parameters in the new SIB (e.g., the command extension parameter) may expanded to support additional commands for autonomous UEs.

The following provides an overview of aspects of the present disclosure:

Aspect 1: A method of wireless communication, comprising: receiving a notification message indicating a transmission of a high-priority message for one or more autonomous user equipments (UEs), receiving the high-priority message, wherein the high-priority message indicates at least one command associated with the one or more autonomous UEs; and performing the at least one command based on the high-priority message.

Aspect 2: The method of aspect 1, wherein the notification message is a broadcast short message.

Aspect 3: The method of aspect 1 or 2, wherein the broadcast short message includes eight bits, and wherein the transmission of the high-priority message is indicated in a fourth bit, a fifth bit, a sixth bit, a seventh bit, or an eighth bit of the broadcast short message.

Aspect 4: The method of any of aspects 1 through 3, wherein the at least one command associated with the one or more autonomous UEs includes at least one of a transmit location command to transmit a current location, a release command to initiate a wireless connection release procedure, a preconfigured travel command to travel to a preconfigured location or along a preconfigured path, a safe location command to travel to a location indicated in the high-priority message, an updated path command to travel along an updated path, a play message command to play at least one of an audio message, a video message, a multimedia message, or a text message, a transmit signal command to transmit at least one of an audio signal, a visual signal or a radio frequency (RF) signal, an altitude change command to change an altitude of the one or more autonomous UEs, an exit area command to travel away from an area, and a stop command to stop for one or more types of vehicles.

Aspect 5: The method of any of aspects 1 through 4, wherein at least a portion of the audio message, the video message, the multimedia message, the text message, the audio signal, the visual signal, the RF signal, a value of the altitude, or the updated path, is included in the high-priority message.

Aspect 6: The method of any of aspects 1 through 5, wherein the location indicated in the high-priority message includes a set of coordinates.

Aspect 7: The method of any of aspects 1 through 6, wherein the at least one command is included in one of a plurality of command classes, wherein each of the plurality of command classes includes a set of commands for a single autonomous UE type, multiple autonomous UE types, or all autonomous UE types.

Aspect 8: The method of any of aspects 1 through 7, further comprising: transmitting a response message based on the high-priority message.

Aspect 9: The method of any of aspects 1 through 8, wherein the high-priority message further indicates information to be transmitted from the one or more autonomous UEs in response to the high-priority message or in response to an initiation or a completion of the at least one command, wherein the information includes acknowledgement information, location information, or an indication of an initiation or completion of a command, and wherein the response message includes the information.

Aspect 10: The method of any of aspects 1 through 9, wherein the one or more autonomous UEs includes at least one of an unmanned aerial vehicle (UAV), an autonomous vehicle (AV), or an autonomous consumer Internet of Things (CIoT) device.

Aspect 11: The method of any of aspects 1 through 10, wherein the high-priority message is a system information block (SIB).

Aspect 12: The method of aspect 11, wherein the system information block (SIB) includes at least one of a message identifier parameter, a serial number parameter, a command parameter, a command extension parameter, a command string parameter, a command response parameter, or a coordinates parameter.

Aspect 13: An apparatus for wireless communication, comprising: a memory; and at least one processor coupled to the memory and configured to perform a method of any one of aspects 1 through 12.

Aspect 14: An apparatus for wireless communication comprising at least one means for performing a method of any one of aspects 1 through 12.

Aspect 15: A computer-readable medium storing computer executable code, the code when executed by a processor cause the processor to perform a method of any one of aspects 1 through 12.

Aspect 16: A method of wireless communication, comprising: transmitting a notification message indicating a transmission of a high-priority message for one or more autonomous user equipments (UEs); and transmitting the high-priority message, wherein the high-priority message indicates at least one command associated with the one or more autonomous UEs.

Aspect 17: The method of aspect 16, wherein the notification message is a broadcast short message.

Aspect 18: The method of aspect 16 or 17, wherein the broadcast short message includes eight bits, and wherein the transmission of the high-priority message is indicated in a fourth bit, a fifth bit, a sixth bit, a seventh bit, or an eighth bit of the broadcast short message.

Aspect 19: The method of any of aspects 16 through 18, further comprising: receiving a request to transmit the at least one command associated with the one or more autonomous UEs, wherein the notification message and the high-priority message are transmitted in response to the request.

Aspect 20: The method of any of aspects 16 through 19, wherein the at least one command associated with the one or more autonomous UEs includes a transmit location command to transmit a current location, a release command to initiate a wireless connection release procedure, a preconfigured travel command to travel to a preconfigured location or along a preconfigured path, a safe location command to travel to a location indicated in the high-priority message, an updated path command to travel along an updated path, a play message command to play at least one of an audio message, a video message, a multimedia message, or a text message, a transmit signal command to transmit at least one of an audio signal, a visual signal or a radio frequency (RF) signal, an altitude change command to change an altitude of the one or more autonomous UEs, an exit area command to travel away from an area, and a stop command to stop for one or more types of vehicles.

Aspect 21: The method of any of aspects 16 through 20, wherein at least a portion of the audio message, the video message, the multimedia message, the text message, the audio signal, the visual signal, the RF signal, a value of the altitude, or the updated path, is included in the high-priority message.

Aspect 22: The method of any of aspects 16 through 21, wherein the location indicated in the high-priority message includes a set of coordinates.

Aspect 23: The method of any of aspects 16 through 22, wherein the at least one command is included in one of a plurality of command classes, wherein each of the plurality of command classes includes a set of commands for a single autonomous UE type, multiple autonomous UE types, or all autonomous UE types.

Aspect 24: The method of any of aspects 16 through 23, further comprising: receiving a response message from the one or more autonomous UEs based on the high-priority message.

Aspect 25: The method of any of aspects 16 through 24, wherein the high-priority message further indicates information to be transmitted from the one or more autonomous UEs in response to the high-priority message or in response to an initiation or a completion of the at least one command, wherein the information includes acknowledgement information, location information, or an indication of an initiation or completion of the at least one command, and wherein the response message includes the information.

Aspect 26: The method of any of aspects 16 through 25, further comprising: forwarding the information in the response message to an autonomous UE management entity or an entity indicated in the response message.

Aspect 27: The method of any of aspects 16 through 26, wherein the at least one processor is further configured to: transmit an update message to one or more controllers of the one or more autonomous UEs based on the response message.

Aspect 28: The method of any of aspects 16 through 27, wherein the one or more autonomous UEs includes at least one of an unmanned aerial vehicle (UAV), an autonomous vehicle (AV), or an autonomous consumer Internet of Things (CIoT) device.

Aspect 29: The method of any of aspects 16 through 28, wherein the high-priority message is a system information block (SIB).

Aspect 30: The method of any of aspects 16 through 29, wherein the system information block (SIB) includes at least one of a message identifier parameter, a serial number parameter, a command parameter, a command extension parameter, a command string parameter, a command response parameter, or a coordinates parameter.

Aspect 31: An apparatus for wireless communication, comprising: a memory; and at least one processor coupled to the memory and configured to perform a method of any one of aspects 16 through 30.

Aspect 32: An apparatus for wireless communication comprising at least one means for performing a method of any one of aspects 16 through 30.

Aspect 33: A computer-readable medium storing computer executable code, the code when executed by a processor cause the processor to perform a method of any one of aspects 16 through 30.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication, comprising:
a memory; and
at least one processor coupled to the memory and configured to:
receive a notification message indicating a transmission of a high-priority message for one or more autonomous user equipments (UEs);
receive the high-priority message, wherein the high-priority message indicates at least one command associated with the one or more autonomous UEs; and
perform the at least one command based on the high-priority message.

2. The apparatus of claim 1, wherein the notification message is a broadcast short message.

3. The apparatus of claim 2, wherein the broadcast short message includes eight bits, and wherein the transmission of the high-priority message is indicated in a fourth bit, a fifth bit, a sixth bit, a seventh bit, or an eighth bit of the broadcast short message.

4. The apparatus of claim 1, wherein the at least one command associated with the one or more autonomous UEs includes at least one of a transmit location command to transmit a current location, a release command to initiate a wireless connection release procedure, a preconfigured travel command to travel to a preconfigured location or along a preconfigured path, a safe location command to travel to a location indicated in the high-priority message, an updated path command to travel along an updated path, a play message command to play at least one of an audio message, a video message, a multimedia message, or a text message, a transmit signal command to transmit at least one of an audio signal, a visual signal or a radio frequency (RF) signal, an altitude change command to change an altitude of the one or more autonomous UEs, an exit area command to travel away from an area, and a stop command to stop for one or more types of vehicles.

5. The apparatus of claim 4, wherein at least a portion of the audio message, the video message, the multimedia message, the text message, the audio signal, the visual signal, the RF signal, a value of the altitude, or the updated path, is included in the high-priority message.

6. The apparatus of claim 4, wherein the location indicated in the high-priority message includes a set of coordinates.

7. The apparatus of claim 1, wherein the at least one command is included in one of a plurality of command classes, wherein each of the plurality of command classes includes a set of commands for a single autonomous UE type, multiple autonomous UE types, or all autonomous UE types.

8. The apparatus of claim 1, wherein the at least one processor is further configured to:
transmit a response message based on the high-priority message.

9. The apparatus of claim 8, wherein the high-priority message further indicates information to be transmitted from the one or more autonomous UEs in response to the high-priority message or in response to an initiation or a completion of the at least one command, wherein the information includes acknowledgement information, location information, or an indication of the initiation or the completion of the at least one command, and wherein the response message includes the information.

10. The apparatus of claim 1, wherein the one or more autonomous UEs includes at least one of an unmanned aerial vehicle (UAV), an autonomous vehicle (AV), or an autonomous consumer Internet of Things (CIoT) device.

11. The apparatus of claim 1, wherein the high-priority message is a system information block (SIB).

12. The apparatus of claim 11, wherein the system information block (SIB) includes at least one of a message identifier parameter, a serial number parameter, a command parameter, a command extension parameter, a command string parameter, a command response parameter, or a coordinates parameter.

13. A method of wireless communication, comprising:
receiving a notification message indicating a transmission of a high-priority message for one or more autonomous user equipments (UEs);
receiving the high-priority message, wherein the high-priority message indicates at least one command associated with the one or more autonomous UEs; and
performing the at least one command based on the high-priority message.

14. The method of claim 13, further comprising:
transmitting a response message based on the high-priority message.

15. An apparatus for wireless communication, comprising:
a memory; and
at least one processor coupled to the memory and configured to:
transmit a notification message indicating a transmission of a high-priority message for one or more autonomous user equipments (UEs); and
transmit the high-priority message, wherein the high-priority message indicates at least one command associated with the one or more autonomous UEs.

16. The apparatus of claim 15, wherein the notification message is a broadcast short message.

17. The apparatus of claim 16, wherein the broadcast short message includes eight bits, and wherein the transmission of the high-priority message is indicated in a fourth bit, a fifth bit, a sixth bit, a seventh bit, or an eighth bit of the broadcast short message.

18. The apparatus of claim 15, wherein the at least one processor is further configured to:
receive a request to transmit the at least one command associated with the one or more autonomous UEs, wherein the notification message and the high-priority message are transmitted in response to the request.

19. The apparatus of claim 15, wherein the at least one command associated with the one or more autonomous UEs includes a transmit location command to transmit a current location, a release command to initiate a wireless connection release procedure, a preconfigured travel command to travel to a preconfigured location or along a preconfigured path, a safe location command to travel to a location indicated in the high-priority message, an updated path command to travel along an updated path, a play message command to play at least one of an audio message, a video message, a multimedia message, or a text message, a transmit signal command to transmit at least one of an audio signal, a visual signal or a radio frequency (RF) signal, an altitude change command to change an altitude of the one or more autonomous UEs, an exit area command to travel away from an area, and a stop command to stop for one or more types of vehicles.

20. The apparatus of claim 19, wherein at least a portion of the audio message, the video message, the multimedia message, the text message, the audio signal, the visual signal, the RF signal, a value of the altitude, or the updated path, is included in the high-priority message.

21. The apparatus of claim 19, wherein the location indicated in the high-priority message includes a set of coordinates.

22. The apparatus of claim 15, wherein the at least one command is included in one of a plurality of command classes, wherein each of the plurality of command classes includes a set of commands for a single autonomous UE type, multiple autonomous UE types, or all autonomous UE types.

23. The apparatus of claim 15, wherein the at least one processor is further configured to:
receive a response message from the one or more autonomous UEs based on the high-priority message.

24. The apparatus of claim 23, wherein the high-priority message further indicates information to be transmitted from the one or more autonomous UEs in response to the high-priority message or in response to an initiation or a completion of the at least one command, wherein the information includes acknowledgement information, location information, or an indication of the initiation or the completion of the at least one command, and wherein the response message includes the information.

25. The apparatus of claim 24, wherein the at least one processor is further configured to:
forward the information in the response message to an autonomous UE management entity or an entity indicated in the response message.

26. The apparatus of claim 23, wherein the at least one processor is further configured to:
transmit an update message to one or more controllers of the one or more autonomous UEs based on the response message.

27. The apparatus of claim 15, wherein the one or more autonomous UEs includes at least one of an unmanned aerial vehicle (UAV), an autonomous vehicle (AV), or an autonomous consumer Internet of Things (CIoT) device.

28. The apparatus of claim 15, wherein the high-priority message is a system information block (SIB).

29. The apparatus of claim 28, wherein the system information block (SIB) includes at least one of a message identifier parameter, a serial number parameter, a command parameter, a command extension parameter, a command string parameter, a command response parameter, or a coordinates parameter.

30. A method of wireless communication, comprising:
transmitting a notification message indicating a transmission of a high-priority message for one or more autonomous user equipments (UEs); and
transmitting the high-priority message, wherein the high-priority message indicates at least one command associated with the one or more autonomous UEs.
